(19) United States
(12) Patent Application Publication
(10) Pub. No.: US 2018/0267001 A1
(43) Pub. Date: Sep. 20, 2018

(54) PHOTOACOUSTIC APPARATUS AND CONTROL METHOD THEREOF, AND PHOTOACOUSTIC PROBE

(71) Applicant: CANON KABUSHIKI KAISHA, Tokyo (JP)

(72) Inventor: Naoto Abe, Machida-shi (JP)

(21) Appl. No.: 15/918,522

(22) Filed: Mar. 12, 2018

(30) Foreign Application Priority Data
Mar. 17, 2017 (JP) 2017-052902
May 31, 2017 (JP) 2017-107949

(51) Int. Cl. G01N 29/32; G01N 29/24

(52) U.S. Cl. CPC G01N 29/326; G01N 2291/02475; G01N 29/2418

(57) ABSTRACT

A photoacoustic apparatus including: a probe including a light source and a receiving unit receiving an acoustic wave generated from an object, which has been irradiated with light from the light source; a temperature information acquiring unit acquiring a temperature of the photoacoustic probe; and a controlling unit controlling irradiation of light by the light source in accordance with the temperature.

### BACKGROUND OF THE INVENTION

### Field of the Invention

The present invention relates to a photoacoustic apparatus and a control method thereof, and to a photoacoustic probe.

### Description of the Related Art

In recent years, photoacoustic apparatuses which perform imaging of the inside of an object using a photoacoustic effect are being studied and developed as an imaging technique utilizing light. A photoacoustic apparatus is an apparatus which uses an ultrasonic wave (a photoacoustic wave) generated by an photoacoustic effect from a light absorber having absorbed energy of light irradiated on an object to generate an image of the inside of the object.

Photoacoustic apparatuses which are shaped like a hand-held probe and which are capable of readily accessing an observation site in a similar manner to ultrasonic diagnostic apparatuses are being studied and developed. Japanese Patent Application Laid-open No. 2016-047077 describes a photoacoustic imaging apparatus including a probe having a light source unit and a receiving unit built therein.

Patent Literature 1: Japanese Patent Application Laid-open No. 2016-047077

### SUMMARY OF THE INVENTION

A part of power supplied to a light source for light emission is converted into heat and causes the light source to generate heat. When a light source is built into a probe (when a light source is arranged inside a housing), there is a possibility that a temperature of the probe may rise due to the generation of heat by the light source. Such a rise in the temperature of the probe may cause a defect in an apparatus due to heat or may lead to inconveniences such as a technician or an examinee experiencing a sense of discomfort.

The present invention has been made in consideration of the problem described above, and an object thereof is to provide a technique for suppressing, in an apparatus having a light source built into a probe, a rise in temperature of the probe due to generation of heat by the light source.

The present invention provides a photoacoustic apparatus, comprising:

a probe configured to include a light source and a receiving unit receiving an acoustic wave generated from an object, which has been irradiated with light from the light source;

a temperature information acquiring unit configured to acquire a temperature of the probe; and

a controlling unit configured to control irradiation of light by the light source in accordance with the temperature.

The present invention also provides a photoacoustic probe, comprising:

a light source;

a receiving unit configured to receive an acoustic wave generated from an object, which has been irradiated with light from the light source;

a temperature information acquiring unit configured to acquire a temperature of the photoacoustic probe; and

a controlling unit configured to control irradiation of light by the light source in accordance with the temperature.

The present invention also provides a photoacoustic apparatus control method comprising:

operating a light source included in a probe to irradiate an object with light;

operating a receiving unit included in the probe to receive an acoustic wave generated from the object, which has been irradiated with the light;

operating a temperature information acquiring unit to acquire a temperature of the probe; and

operating a controlling unit to control irradiation of light by the light source in accordance with the temperature.

According to the present invention, a technique can be provided for suppressing, in an apparatus having a light source built into a probe, a rise in temperature of the probe due to generation of heat by the light source.

Further features of the present invention will become apparent from the following description of exemplary embodiments with reference to the attached drawings.

### BRIEF DESCRIPTION OF THE DRAWINGS

FIG. 1 is a block diagram of a photoacoustic apparatus according to a first embodiment;

FIG. 2 is a schematic diagram of a hand-held probe according to the first embodiment;

FIG. 3 is a block diagram showing a computer and a peripheral configuration thereof according to the first embodiment;

FIGS. 4A to 4C are timing charts for explaining an exothermic amount per unit time;

FIG. 5 is a flow chart of control of the first embodiment;

FIGS. 6A and 6B are graphs for explaining a light irradiation control method in a tracking-prioritized protective mode;

FIGS. 7A and 7B are other graphs for explaining a light irradiation control method in the tracking-prioritized protective mode;

FIGS. 8A and 8B are graphs for explaining a light irradiation control method in an image quality-prioritized protective mode;

FIGS. 9A and 9B are other graphs for explaining a light irradiation control method in the image quality-prioritized protective mode;

FIGS. 10A and 10B are graphs for explaining a light irradiation control method in a normal protective mode;

FIG. 11 is a flow chart of control of a second embodiment;

FIGS. 12A and 12B are graphs for explaining a light irradiation control method according to the second embodiment;

FIG. 13 is a flow chart of control of a third embodiment;

FIG. 14 is a graph for selecting a characteristic curve based on a speed and a pressing force of a probe; and

FIGS. 15A to 15D are flow charts of control of a seventh embodiment.

### DESCRIPTION OF THE EMBODIMENTS

Hereinafter, preferred embodiments of the present invention will be described with reference to the drawings. However, it is to be understood that dimensions, materials, shapes, relative arrangements, and the like of components described below are intended to be changed as deemed appropriate in accordance with configurations and various conditions of apparatuses to which the present invention is to be applied. Therefore, the scope of the present invention is not intended to be limited to the embodiments described below.

The present invention relates to a technique for detecting an acoustic wave propagating from an object and generating and acquiring characteristic information on the inside of the object. Accordingly, the present invention can be considered an object information acquiring apparatus or a control method thereof, or an object information acquiring method and a signal processing method. The present invention can also be considered a display method for generating and displaying an image indicating characteristic information on the inside of an object. The present invention can also be considered a program that causes an information processing apparatus including hardware resources such as a CPU and a memory to execute these methods or a computer-readable non-transitory storage medium storing the program.

The object information acquiring apparatus according to the present invention includes a photoacoustic imaging apparatus utilizing a photoacoustic effect in which an acoustic wave generated inside an object by irradiating the object with light (an electromagnetic wave) is received and characteristic information on the object is acquired as image data. In this case, characteristic information refers to information on a characteristic value corresponding to each of a plurality of positions inside the object which is generated using a signal derived from a received photoacoustic wave.

Photoacoustic image data according to the present invention is a concept encompassing all image data derived from a photoacoustic wave generated by light irradiation. For example, photoacoustic image data is image data representing at least one piece of characteristics information such as generated sound pressure (initial sound pressure), energy absorption density, and an absorption coefficient of a photoacoustic wave, and a concentration of a substance constituting the object (for example, oxygen saturation). Moreover, photoacoustic image data indicating spectral information such as a concentration of a substance constituting the object is obtained based on photoacoustic waves generated by irradiating light with a plurality of wavelengths that differ from each other. Photoacoustic image data indicating spectral information may be oxygen saturation, a value obtained by weighting oxygen saturation with intensity of an absorption coefficient or the like, a total hemoglobin concentration, an oxyhemoglobin concentration, or a deoxyhemoglobin concentration. Alternatively, photoacoustic image indicating spectral information may be a glucose concentration, a collagen concentration, a melanin concentration, or a volume fraction of fat or water.

A two-dimensional or three-dimensional characteristic information distribution is obtained based on characteristic information at each position in the object. Distribution data may be generated as image data. Characteristic information may be obtained as distribution information on respective positions inside the object instead of as numerical data. In other words, distribution information such as an initial sound pressure distribution, an energy absorption density distribution, an absorption coefficient distribution, and an oxygen saturation distribution can be obtained.

An acoustic wave according to the present invention is typically an ultrasonic wave and includes an elastic wave which is also referred to as a sonic wave or an acoustic wave. A signal (for example, an electrical signal) transformed from an acoustic wave by a transducer or the like is also referred to as an acoustic signal. However, descriptions of an ultrasonic wave and an acoustic wave in the present specification are not intended to limit a wavelength of the elastic waves. An acoustic wave generated by a photoacoustic effect is referred to as a photoacoustic wave or an optical ultrasonic wave. A signal (for example, an electrical signal) derived from a photoacoustic wave is also referred to as a photoacoustic signal. Distribution data is also referred to as photoacoustic image data or reconstructed image data.

In the following embodiments, a photoacoustic probe which includes a light source and a receiving unit and which is used when acquiring a photoacoustic signal will be described in detail. Therefore, the present invention can also be considered a photoacoustic probe and a control method thereof. In addition, while a hand-held photoacoustic probe is described in the following embodiments, a probe according to the present invention is not limited to a hand-held probe.

In photoacoustic measurement, generally, the larger a light amount of irradiation light, the higher the intensity of photoacoustic waves and the higher the S/N of a received signal of a photoacoustic wave. As a result, photoacoustic image data with high image quality when displayed is obtained.

With a hand-held probe of a photoacoustic apparatus, a configuration is conceivable in which a light source is arranged inside a probe housing. Even in such a configuration, a light amount of irradiation light is desirably increased in order to display a photoacoustic image with high image quality. However, since the light source generates heat when a part of power supplied to the light source is converted into heat, supplying a large amount of power to the light source for the purpose of increasing a light amount of irradiation light also results in increasing an exothermic amount of the light source.

In the present specification, a “light amount” will be defined as a total amount (in units of J (joule)) of optical energy per pulse (hereinafter, also referred to as an irradiated light amount). In addition, a product of a light amount multiplied by the number of light emissions (a repetition frequency of light irradiation) per second will be defined as an average power (in units of W (watt)) of irradiation light.

For example, when light is emitted using a laser diode as a light source at a light amount of 0.01 [J] at 0.1 second intervals (when light is emitted 10 times in one second), the average power of irradiation light is 0.01 [J]×10 [times/s]=0.1 [W]. In this case, when a photoelectric conversion efficiency with respect to supplied power is assumed to be 10 [%], supplied power of 1 [W] is required to produce an average power of 0.1 [W]. In this case, the exothermic amount per unit time of the light source is 0.9 [W]. Furthermore, in this case, it is assumed that all of the power not converted into light among the power supplied to the light source is to be converted into heat. Moreover, light of one pulse includes, in addition to light of which a time variation of light intensity is a square wave, light of which a time variation of light intensity represents all waveforms including a triangular wave and a sinusoidal wave.

It is difficult to provide a hand-held probe with a cooling mechanism such as a forced air-cooling mechanism or a water-cooling mechanism. Therefore, even when an exothermic amount of a light source provided inside the housing is small, the temperature inside the housing may possibly rise. The rise in temperature may possibly cause a device defect inside the housing. In addition, the rise in temperature of the housing may cause a user handling the probe such as a technician or a physician or a patient who is an examinee to experience a sense of discomfort.

In consideration thereof, after conducting intensive studies, the present inventors have arrived at mounting a temperature information acquiring unit such as a temperature sensor inside a hand-held probe or a housing and optimally controlling a light amount and a repetition frequency of light irradiation based on a temperature detected by the temperature sensor. In other words, the present inventors have arrived at controlling the light amount and the repetition frequency of light irradiation such that the temperature inside the hand-held probe or the housing does not exceed an upper limit value determined in advance to control power supplied to the light source. Typically, the light amount and the repetition frequency are optimally controlled by appropriately adjusting power supplied to the light source so that a rise in temperature due to an exothermic amount proportional to a value obtained by multiplying the light amount of irradiation light with the repetition frequency of light irradiation equals or falls below a permissible temperature.

In addition, when an object is the skin of a human body or the like, maximum permissible exposure (MPE) must be observed. In addition to a restriction in consideration of a temperature inside the hand-held probe or a housing temperature, a restriction may be applied so that the light amount does not exceed MPE.

Moreover, subjects of application of the present invention are not limited to the photoacoustic apparatus described in the following embodiments. The present invention is applicable to any apparatus in which a light source is built into a hand-held probe. For example, the present invention may be applied to a hand-held probe having a built-in light source and a built-in light receiving element which receives reflected light or transmitted light of light emitted from the light source. In other words, the present invention may be applied to an apparatus including a hand-held probe with a built-in light source and an information acquiring unit which acquires information related to an irradiation target based on a received signal of light having propagated through the irradiation target.

### First Embodiment

Apparatus Configuration

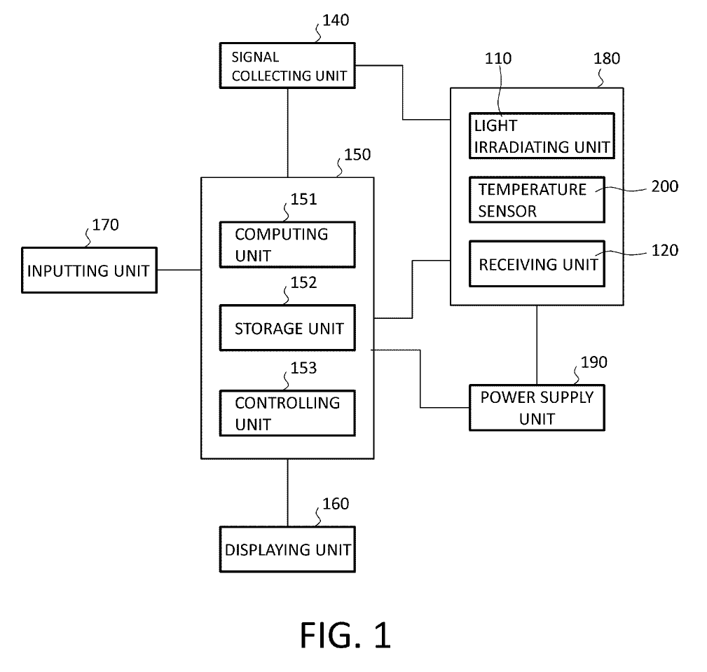

Hereafter, a configuration of a photoacoustic apparatus according to the present embodiment will be described with reference to FIG. 1. FIG. 1 is a schematic block diagram of an entire photoacoustic apparatus. The photoacoustic apparatus according to the present embodiment includes a probe 180 (a light irradiating unit 110, a receiving unit 120, and a temperature sensor 200), a signal collecting unit 140, a computer 150, a displaying unit 160, an inputting unit 170, and a power supply unit 190.

When the light irradiating unit 110 irradiates light to an object 100, due to a photoacoustic effect, a photoacoustic wave is generated from a light absorber inside or on a surface of the object 100. The power supply unit 190 supplies power for driving a light source of the light irradiating unit 110. The receiving unit 120 receives a photoacoustic wave and outputs an electrical signal (a photoacoustic signal) as an analog signal.

The signal collecting unit 140 converts the analog signal output from the receiving unit 120 into a digital signal and outputs the digital signal to the computer 150. The computer 150 stores the digital signal output from the signal collecting unit 140 as a signal data derived from a photoacoustic wave.

The computer 150 generates image data by performing processes to be described later on the stored digital signal. In addition, after performing image processing for display on the obtained image data, the computer 150 outputs the image data to the displaying unit 160. The displaying unit 160 displays a photoacoustic image. A physician, a technician, or the like as a user can carry out a diagnosis by checking the photoacoustic image displayed on the displaying unit 160. The display image is stored in a memory inside the computer 150, a data management system connected to a modality via a network, or the like based on a storage instruction from the user or the computer 150.

As a reconstruction algorithm for converting signal data into three-dimensional volume data, any method such as a time-domain back-projection method, a Fourier domain back-projection method, and a model-based method (a repeat operation method) can be adopted. Examples of a time-domain back-projection method include Universal back-projection (UBP), Filtered back-projection (FBP), and phasing addition (Delay-and Sum). Moreover, in image reconstruction, an absorption coefficient distribution is acquired based on an initial sound pressure distribution of photoacoustic waves and a light amount distribution inside the object. In the present invention, since an irradiated light amount dynamically changes in accordance with a temperature of a probe, a light amount distribution inside the object also changes. In consideration thereof, when the computer performs image reconstruction, signal data is favorably corrected using a method of applying a gain or the like as necessary with reference to light amount information at the point of acquisition of a photoacoustic wave.

Furthermore, the displaying unit 160 may display a GUI and the like in addition to images generated by the computer 150. The inputting unit 170 is configured so as to accept input of information by the user. Using the inputting unit 170, the user can perform operations such as starting and ending a measurement and issuing an instruction to save a created image.

Probe 180

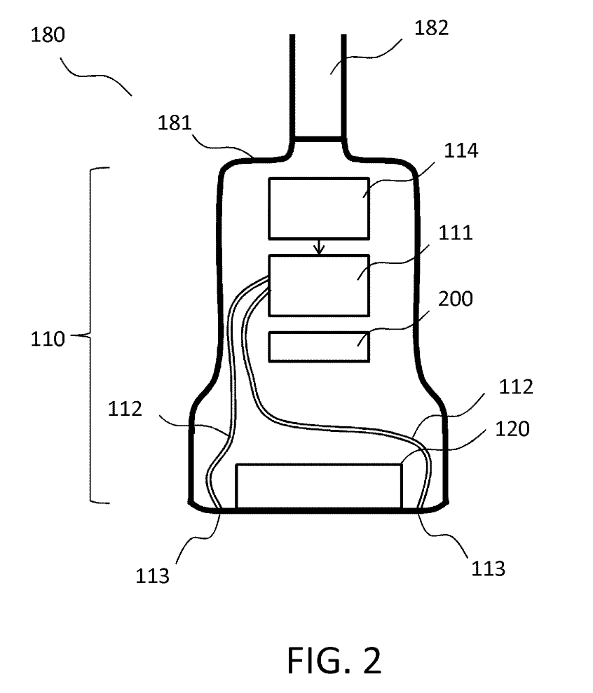

FIG. 2 is a schematic diagram of the hand-held probe 180 according to the present embodiment. The probe 180 includes the light irradiating unit 110, the receiving unit 120, the temperature sensor 200, and a housing 181.

As an installation location of the temperature sensor 200 inside the probe 180, a vicinity of the light source or a driver circuit 114 of the light irradiating unit 110 which is subjected to strict operating temperature conditions or the housing 181 which is a movable portion is favorable. The temperature sensor 200 is mounted to such a preferable installation location by thermal coupling. The temperature sensor 200 outputs a temperature of the inside of the probe (for example, a position in a vicinity of the light source) or a temperature of the housing (hereinafter, may also be simply referred to as a probe temperature) to the computer 150 as an analog signal or a digital signal.

The housing 181 is a housing that encloses the light irradiating unit 110 and the receiving unit 120. By gripping the housing 181, the user can use the probe 180 as a hand-held probe.

The light irradiating unit 110 includes a light source 111, an optical system 112 which propagates light generated from the light source 111, and the driver circuit 114 which drives the light source 111. The optical system 112 propagates light generated from the light source 111 which is an LED, an LD, or the like and emits the light from an exit end 113.

The probe 180 is connected to the signal collecting unit 140, the computer 150, and the power supply unit 190 via a cable 182. The cable 182 includes a wiring for supplying power from the power supply unit 190 to the driver circuit 114, a wiring for sending a control signal which controls a light amount, a light emission timing, and the like from the controlling unit 153 to the driver circuit 114, and a wiring for transmitting an analog signal output from the receiving unit 120 to the signal collecting unit 140. The cable 182 may be provided with a connector and configured so as to enable the probe 180 to be separated from other components of the photoacoustic apparatus. In the present embodiment, a configuration combining the driver circuit 114 and the power supply unit 190 corresponds to the driving unit which supplies power to the light source 111. In other words, the driving unit according to the present embodiment includes the driver circuit 114 and the power supply unit 190.

Moreover, the probe 180 according to the present embodiment may be a wireless hand-held probe 180 without the cable 182. In this case, the power supply unit 190 may be built into the probe 180 and various signals may be transmitted and received between the probe 180 and the other components in a wireless manner. However, when the power supply unit 190 is built into the probe 180, an exothermic amount inside the housing 181 increases due to heat generated by power consumption at the power supply unit 190. Therefore, in order to suppress a rise in temperature inside the housing 181, the power supply unit 190 may be arranged outside of the housing 181. In addition, a part of the components of the driver circuit 114 which have a high power consumption and a large exothermic amount may be arranged outside of the housing 181.

Detailed Components

Hereafter, details of the respective components of the photoacoustic apparatus according to the present embodiment will be described.

Light Irradiating Unit 110

The light irradiating unit 110 includes the light source 111, the optical system 112, and the driver circuit 114.

A laser diode (LD) or a light-emitting diode (LED) is preferable as the light source 111. As the light source 111, an LD or an LED capable of emitting light so as to follow a serrated driving waveform (driving current) of 1 MHz or higher may be adopted. However, light sources are not limited to an LD or an LED as long as light for generating a photoacoustic wave can be emitted. In addition, oxygen saturation can be acquired by using a wavelength-variable light source as the light source 111.

A pulse width of light emitted by the light source 111 is typically at least 1 ns and not more than 1 μs. Moreover, a range from approximately 400 nm to 1600 nm can be used as a wavelength of light. When imaging a blood vessel at high resolution, a wavelength (at least 400 nm and not more than 700 nm) which is well absorbed by the blood vessel is favorable. When imaging a deep part of a living organism, light with a wavelength (at least 700 nm and not more than 1100 nm) which is typically weakly absorbed by background tissue (water, fat, and the like) of the living organism is favorable. However, pulse widths and wavelengths are not limited to those described above.

An optical element such as a lens, a mirror, and an optical fiber can be used as the optical system 112. When a breast or the like is used as the object 100, a diffuser plate or the like may be used as the exit end 113 of the optical system in order to irradiate the object 100 with pulsed light having a widened beam diameter. On the other hand, in a photoacoustic microscope, in order to increase resolution, the exit end 113 of the optical system 112 may be constituted by a lens or the like in order to irradiate a focused beam. Alternatively, light may be directly irradiated from the light source 111 to the object 100 without providing the light irradiating unit 110 with the optical system 112.

The driver circuit 114 is a circuit which generates a driving current for driving the light source 111 using power from the power supply unit 190.

Receiving Unit 120

The receiving unit 120 includes a transducer which outputs an electrical signal by receiving an acoustic wave and a supporter which supports the transducer. As a member constituting the transducer, a piezoelectric ceramic material represented by lead zirconate titanate (PZT), a polymer piezoelectric film material represented by polyvinylidene fluoride (PVDF), and the like can be used. Besides piezoelectric elements, a capacitive transducer (capacitive micro-machined ultrasonic transducer: CMUT) or a transducer using a Fabry-Perot interferometer can be used. Any kind of transducer may be adopted as long as an acoustic wave can be received and an electrical signal can be output. Since a frequency component constituting a photoacoustic wave is typically 100 KHz to 100 MHz, a transducer capable of detecting these frequencies is favorably used.

A signal obtained by a transducer is a time-resolved signal. In other words, an amplitude of a signal obtained by a transducer represents a value based on sound pressure (for example, a value proportional to sound pressure) received by the transducer at each time point.

The supporter may arrange a plurality of transducers side by side on a flat surface or a curved surface which is referred to as a 1D array, a 1.5D array, a 1.75D array, or a 2D array.

In addition, the receiving unit 120 may include an amplifier for amplifying a time-sequential analog signal output from the transducer. Furthermore, the receiving unit 120 may include an A/D converter for converting a time-sequential analog signal output from the transducer into a time-sequential digital signal. In other words, the receiving unit 120 may include the signal collecting unit 140 to be described later.

When using a plurality of transducers, ideally, a transducer arrangement which enables the transducers to surround an entire perimeter of the object 100 is favorable. However, when the object 100 is large, it is impossible to arrange the transducers so as to surround the entire perimeter of the object 100. In this case, by arranging the transducers on a hemispherical supporter, acoustic waves propagating in many directions from the object 100 can be received. Moreover, the arrangement and the number of the transducers and the shape of the supporter may be optimized in accordance with the object and are not limited to those described above.

A medium that acoustically matches the receiving unit 120 and the object 100 with each other may be arranged in a space between the receiving unit 120 and the object 100. As the medium, a material of which acoustic characteristics match at an interface with the object 100 or the transducers and of which transmittance of photoacoustic wave is as high as possible is adopted. For example, water, oil, an ultrasonic gel, and the like can be adopted as the medium.

In addition, when the apparatus according to the present embodiment generates an ultrasonic image in addition to a photoacoustic image by transmitting and receiving acoustic waves, the transducer may function as a transmitting unit that transmits an acoustic wave. A transducer as a receiving unit and a transducer as a transmitting unit may be a single (common) transducer or may be separate components.

Temperature Sensor 200

The temperature sensor 200 which is the temperature information acquiring unit according to the present embodiment will now be described. For example, the temperature sensor 200 can be constituted by a sensor such as a thermistor, a thermocouple, and a thermometric resistor. The temperature sensor 200 may be installed in a vicinity of the light source 111 subjected to strict operating temperature conditions (having a low upper limit temperature). In addition, when the housing 181 which is a movable portion is subjected to strict temperature restrictions (has a low upper limit temperature), the temperature sensor 200 is desirably mounted to the housing 181 by thermal coupling. The apparatus according to the present invention controls at least one of a light amount and a light irradiation timing (typically, a repetition frequency) so that the temperature of the temperature sensor 200 does not exceed an upper limit determined in advance. Control related to the light irradiation is performed by controlling power supplied to the light source. Therefore, the temperature sensor 200 must be mounted by thermal coupling to a portion of which a rise in temperature is desirably managed.

Moreover, as the temperature information acquiring unit, instead of the temperature sensor 200 which directly measures temperature, an apparatus may be used which acquires temperature information by computations based on an amount of power supplied to the light source, an exothermic amount acquired based on the amount of power and photoelectric conversion efficiency, a thermal capacity of the probe, and the like. In addition to the above, any system may be adopted as long as desired temperature information can be acquired.

Signal Collecting Unit 140

The signal collecting unit 140 includes an amplifier which amplifies an electrical signal that is an analog signal output from the receiving unit 120 and an A/D converter which converts an analog signal output from the amplifier into a digital signal. The signal collecting unit 140 may be constituted by a field programmable gate array (FPGA) chip or the like. A digital signal output from the signal collecting unit 140 is stored in a storage unit 152 inside the computer 150. The signal collecting unit 140 is also referred to as a data acquisition system (DAS). In the present specification, an electrical signal is a concept encompassing both analog signals and digital signals.

Moreover, the signal collecting unit 140 may start processing in synchronization with the emission of light from the light irradiating unit 110 as a trigger. As the trigger, a signal output from a light detecting sensor mounted to the exit end 113 of the light irradiating unit 110 can be used. Alternatively, the signal collecting unit 140 may start processing upon receiving an instruction signal to start measurement from the inputting unit 170.

Moreover, the probe 180 may include the signal collecting unit 140 constituted by an amplifier, an ADC, and the like. In other words, the signal collecting unit 140 may be arranged inside the housing 181. With such a configuration, since information between the hand-held probe 180 and the computer 150 can be propagated using digital signals, noise immunity can be improved. In addition, the use of high-speed digital signals enables the number of wirings to be reduced and operability of the hand-held probe 180 to be improved as compared to transmitting analog signals.

Computer 150

The computer 150 as the information processing unit includes a computing unit 151, the storage unit 152, and a controlling unit 153. Descriptions of functions of the respective components will be given when describing process flows.

A unit which provides a computation function as the computing unit 151 may be constituted by a processor such as a CPU or a graphics processing unit (GPU) or an arithmetic circuit such as a field programmable gate array (FPGA) chip. Such units may not only be constituted by a single processor or a single arithmetic circuit and may also be constituted by a plurality of processors or a plurality of arithmetic circuits. The computing unit 151 may accept various parameters including object sound velocity and a configuration of a holding unit from the inputting unit 170 to process a received signal.

The storage unit 152 can be constituted by a non-transitory storage medium such as a read only memory (ROM), a magnetic disk, and a flash memory. Alternatively, the storage unit 152 may be a volatile medium such as a random access memory (RAM). Moreover, a storage medium in which a program is to be stored is a non-transitory storage medium. Alternatively, the storage unit 152 may be constituted by a plurality of storage media. The storage unit 152 may be connected online to the computer 150. The storage unit 152 is capable of storing photoacoustic image data generated by the computing unit 151 and a display image based on the photoacoustic image data.

The controlling unit 153 is constituted by an arithmetic element such as a CPU. The controlling unit 153 controls operations of each component of the photoacoustic apparatus. The controlling unit 153 may control operations of each component of the photoacoustic apparatus upon receiving instruction signals in accordance with various operations such as start of measurement from the inputting unit 170. In addition, the controlling unit 153 controls operations of each component of the photoacoustic apparatus by reading a program code stored in the storage unit 152. The computer 150 may be an exclusively designed work station. Alternatively, the respective components of the computer 150 may be constituted by different pieces of hardware which operate in cooperation with one another.

Output of the temperature sensor 200 is input to the controlling unit 153 by an analog signal or a digital signal. When the output of the temperature sensor 200 is sent to the controlling unit 153 by an analog signal, control is preferably performed by converting the analog signal into a digital signal with an A/D converter (not shown) inside the controlling unit 153. The controlling unit 153 of the computer 150 controls operations of the respective components included in the photoacoustic apparatus and, at the same time, controls light irradiation based on a temperature detected by the temperature sensor. Specifically, a repetition frequency of light irradiation and an irradiated light amount are controlled. In addition, in the respective embodiments to be described later, a speed detected by a speed sensor or a pressing force detected by a pressure sensor are used to control light irradiation.

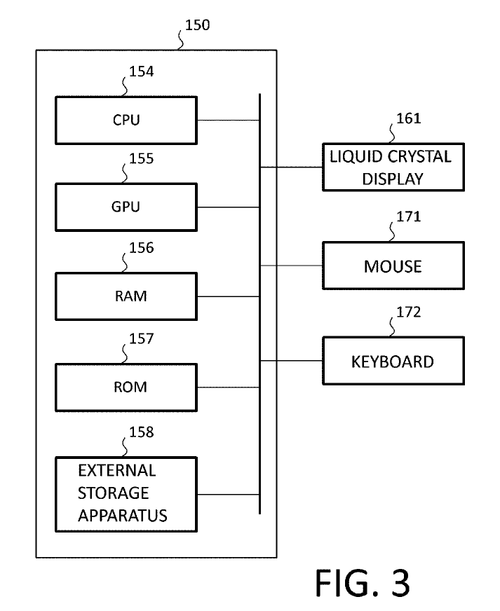

FIG. 3 shows a specific configuration example of the computer 150 according to the present embodiment. The computer 150 according to the present embodiment is constituted by a CPU 154, a GPU 155, a RAM 156, a ROM 157, and an external storage apparatus 158. In addition, a liquid crystal display 161 as the displaying unit 160, and a mouse 171 and a keyboard 172 as the inputting unit 170 are connected to the computer 150.

In addition, the computer 150 and the receiving unit 120 may be configured so as to be housed in a common housing. In this case, the photoacoustic probe can be used as a stand-alone photoacoustic apparatus.

Alternatively, a part of signal processing may be performed by a computer housed in a housing and remaining signal processing may be performed by a computer provided outside of the housing. In this case, the computers provided inside and outside of the housing can be collectively considered the computer according to the present embodiment. In other words, hardware constituting the computer need not be housed in a single housing.

Displaying Unit 160

The displaying unit 160 is a display such as a liquid crystal display and an organic electro luminescence (EL) display. The displaying unit 160 is an apparatus which displays an image, a numerical value of a specific position, and the like based on object information and the like obtained by the computer 150. The displaying unit 160 may display a GUI for operating images and the apparatus. Moreover, object information can also be displayed after performing image processing (adjustment of a brightness value and the like) with the displaying unit 160 or the computer 150.

Inputting Unit 170

As the inputting unit 170, an operation console which is constituted by a mouse, a keyboard, and the like and which can be operated by the user can be used. Alternatively, the displaying unit 160 may be constituted by a touch panel, in which case the displaying unit 160 may be used as the inputting unit 170.

Moreover, each component of the photoacoustic apparatus may be respectively configured as a separate apparatus or may be configured as a single integrated apparatus. In addition, at least a part of the components of the photoacoustic apparatus may be configured as a single integrated apparatus.

Power Supply Unit 190

The power supply unit 190 is a power supply which generates power. The power supply unit 190 supplies power to the driver circuit 114 of the light irradiating unit 110. When power supplied from the power supply unit 190 is consumed by the driver circuit 114, the light source 111, and the like, heat is generated together with light. A DC power supply or any kind of battery such as a primary battery and a secondary battery can be used as the power supply unit 190. When the power supply unit 190 is constituted by a battery, the power supply unit 190 can be housed in the probe 180 in a space-saving manner. Moreover, the driver circuit 114 and the power supply unit 190 may be controlled by the controlling unit 153 in the computer 150. Alternatively, the probe 180 may include a controlling unit which controls the power supply unit 190 and the driver circuit 114.

Object 100

Although the object 100 does not constitute the photoacoustic apparatus, a description thereof will be given below. The photoacoustic apparatus according to the present embodiment can be used for the purposes of diagnosing a malignant tumor, a vascular disease, and the like, performing a follow-up observation of chemotherapy, and the like of a human or an animal. Therefore, as the object 100, a diagnostic subject site such as a living organism or, more specifically, a breast, each internal organ, the vascular network, the head, the neck, the abdominal area, and the extremities including fingers and toes of a human or an animal is assumed. For example, when the measurement subject is a human body, a subject of a light absorber may be oxyhemoglobin, deoxyhemoglobin, a blood vessel containing oxyhemoglobin or deoxyhemoglobin in a large amount, or a new blood vessel formed in a vicinity of a tumor. In addition, the subject of a light absorber may be a plaque on a carotid artery wall or the like. Furthermore, pigments such as methylene blue (MB) and indocyanine green (ICG), gold particulates, or an externally introduced substance which accumulates or which is chemically modified with such pigments or gold particulates may be used as a light absorber. Moreover, a puncture needle or a light absorber added to a puncture needle may be considered an observation object.

Control Method of Light Source and Exothermic Amount per Unit Time

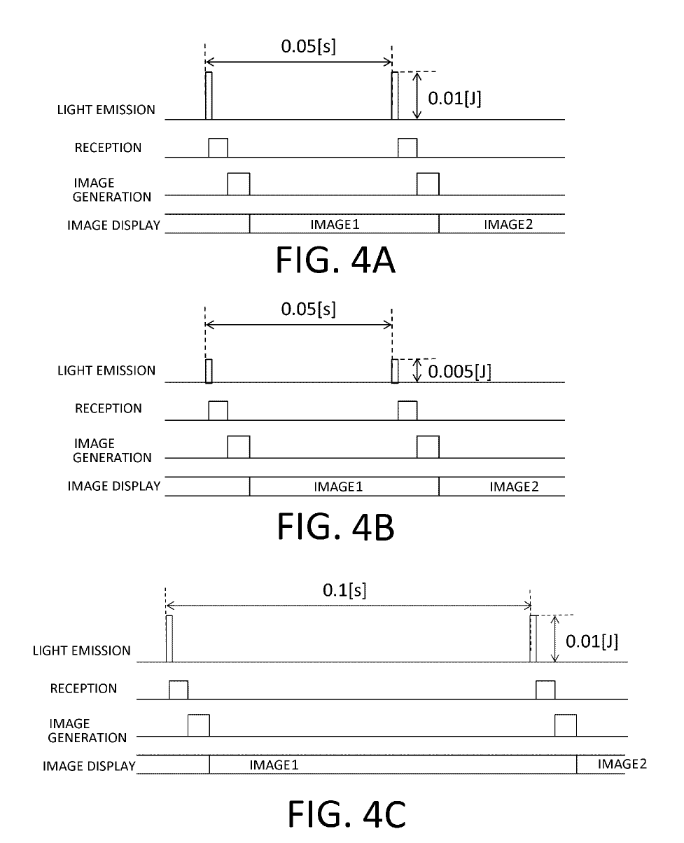

FIGS. 4A to 4C are timing charts for explaining a control method and an exothermic amount per unit time of a light source according to the present embodiment. FIGS. 4A to 4C show respective timings of emission of irradiation light, reception of a photoacoustic wave, generation of image data, and display of image data. A vertical axis in the timing chart of “light emission” represents an irradiated light amount. Moreover, in FIGS. 4A to 4C, a value proportional to power supplied to the light source 111 is assumed as the irradiated light amount.

In FIG. 4A, a refresh frequency of image display is set to 20 [Hz] which enables display so as to track a normal movement of the hand-held probe. In FIG. 4A, the refresh frequency of image display matches a repetition frequency of light irradiation.

At a timing indicated in “light emission” in FIG. 4A, the controlling unit 153 sets a light amount setting value of 0.01 [J] to the driver circuit 114 and outputs a light emission timing signal to the driver circuit 114 at 0.05 second intervals. The driver circuit 114 drives the light source 111 according to the light emission timing signal and information on the light amount setting value from the controlling unit 153.

Subsequently, at a timing indicated in “reception” in FIG. 4A, the receiving unit 120 receives a photoacoustic wave created due to light from the light source 111. The computing unit 151 performs a reconstruction process based on a signal output by the receiving unit 120 at a timing indicated in “image generation” in FIG. 4A, and generates image data. Subsequently, the controlling unit 153 transmits the image data to the displaying unit 160 and causes the displaying unit 160 to display an image based on the image data. The displaying unit 160 displays an image based on the image data during a period indicated in “image display” in FIG. 4A.

In the timing chart shown in FIG. 4A, an image 1 is first displayed for 0.05 seconds and an image 2 is next displayed for 0.05 seconds. By repeating the steps described above, image display based on new image data is updated every 0.05 seconds. As described earlier, an exothermic amount per unit time of the hand-held probe is determined by a light amount of light and a repetition frequency of light irradiation. In the case of FIG. 4A, assuming that the photoelectric conversion efficiency with respect to supplied power is 10 [%] and setting the irradiated light amount to 0.01 [J], the exothermic amount per unit time of the light source 111 is 0.09 [J]×(1/0.05)=1.8 [W].

FIG. 4B is a timing chart which shares the same repetition frequency of light irradiation but differs in the light amount from FIG. 4A. In FIG. 4B, the repetition frequency is 20 [Hz] and light is irradiated in a period of 0.05 seconds in the same manner as in FIG. 4A. In addition, since the display image is also updated every 0.05 seconds, trackability is also similar to FIG. 4A. On the other hand, the irradiated light amount in FIG. 4B is set to 0.005 [J] which is half of that in FIG. 4A. According to such settings, the exothermic amount per unit time of the light source 111 has declined to 0.9 [W].

FIG. 4C is a timing chart which shares the same light amount but differs in the repetition frequency of light irradiation from FIG. 4A. The irradiated light amount in FIG. 4C is 0.01 [J] which is the same as in FIG. 4A. Therefore, an S/N ratio of each obtained reconstructed image is similar to that of the reconstructed images obtained in FIG. 4A. On the other hand, the repetition frequency of light irradiation in FIG. 4C is 10 [Hz] or, in other words, a period of 0.1 seconds, and a period of repetition of light irradiation (a light emission period) is twice that of FIG. 4A. According to such settings, the exothermic amount per unit time of the light source 111 has declined to 0.9 [W].

As described above, it is found that the exothermic amount per unit time of the light source 111 which repetitively performs light irradiation can be controlled by the repetition frequency of light irradiation and the irradiated light amount.

Protective Modes

The present invention provides a method of optimally controlling the two conditions of repetition frequency and irradiated light amount based on a temperature detected by the temperature sensor 200. Specifically, when the detected temperature of the temperature sensor exceeds a permissible value, the computer according to the present invention suppresses light emission by the light source to prevent a temperature of electronic elements inside the probe 180 from rising, and prevents thermal destruction of the electronic elements. In addition, a rise in temperature of the housing 181 is suppressed to prevent a patient or a user from experiencing a sense of discomfort.

In the first embodiment of the present invention, first, a user uses the inputting unit 170 to specify a protective mode for preventing a rise in temperature of the probe 180 from a plurality of modes. For example, in order to enable a “normal protective mode”, a “tracking-prioritized protective mode”, and an “image quality-prioritized protective mode” to be selected, icons or the like may be displayed on the displaying unit 160 and a selection may be made using the mouse 171 or the keyboard 172. In addition, in order to save the effort of making a selection each time a measurement is performed, a default protective mode may be determined in advance in accordance with an object, an imaging mode, or the like. In this case, favorably, the user is capable of changing from a default protective mode using the inputting unit 170. While three protective modes are provided in the first embodiment, the number of protective modes is not limited thereto, and one or two protective modes may be provided or four or more protective modes may be provided.

The “tracking-prioritized protective mode” is a protective mode in which the refresh frequency of image display (in other words, the repetition frequency of light irradiation) is not lowered. The “image quality-prioritized protective mode” is a protective mode in which S/N of each reconstructed image is maintained so as not to deteriorate. The “normal protective mode” is a protective mode which provides a balance between trackability and image quality (S/N). Hereinafter, operations of each protective mode will be described.

In the “tracking-prioritized protective mode”, when the temperature of the probe 180 rises, control for reducing the irradiated light amount is performed to reduce the exothermic amount per unit time of the light source 111 before lowering the repetition frequency of light irradiation. Alternatively, when the temperature of the probe 180 rises, control is performed to reduce the irradiated light amount by a larger amount than an amount by which the repetition frequency of light irradiation is lowered to reduce the exothermic amount per unit time of the light source 111. By performing control in this manner, since the refresh frequency of image display (in other words, the repetition frequency of light irradiation) does not decrease when an increase in temperature is small, a reconstructed image with good trackability can be obtained.

In the “image quality-prioritized protective mode”, when the temperature of the probe 180 rises, control for lowering the repetition frequency of light irradiation is performed before reducing the irradiated light amount to reduce the exothermic amount per unit time of the light source 111. Alternatively, when the temperature of the probe 180 rises, control is performed to lower the repetition frequency of light irradiation by a larger amount than an amount by which the irradiated light amount is reduced to reduce the exothermic amount per unit time of the light source 111. By performing control in this manner, since the irradiated light amount does not decrease when an increase in temperature is small, a reconstructed image with good S/N can be obtained.

In the “normal protective mode”, control which provides a balance between image quality and trackability is performed. In other words, when the temperature of the probe 180 rises, control is performed to reduce both the irradiated light amount and the repetition frequency of light irradiation while providing a balance therebetween to reduce the exothermic amount per unit time of the light source 111. For example, when the default repetition frequency of light irradiation is sufficiently high, the repetition frequency of light irradiation may be preliminarily lowered, and when the default irradiated light amount is large, the irradiated light amount may be preliminarily reduced. In the “normal protective mode”, control is performed such that a user observing a reconstructed image does not sense a degradation of image quality (S/N) and trackability. By performing control in this manner, the exothermic amount per unit time of the light source 111 can be suppressed while reducing both image quality and trackability so as to provide a balance therebetween.

Moreover, control in the normal protective mode is not limited to one type of control. For example, the user may be enabled to specify a ratio at which each of light amount control and repetition frequency control contributes to suppressing heat generation. When specifying the ratio, the user can use an UI such as a slide bar displayed on the displaying unit or a physical knob using a variable resistor or the like.

Control Flow

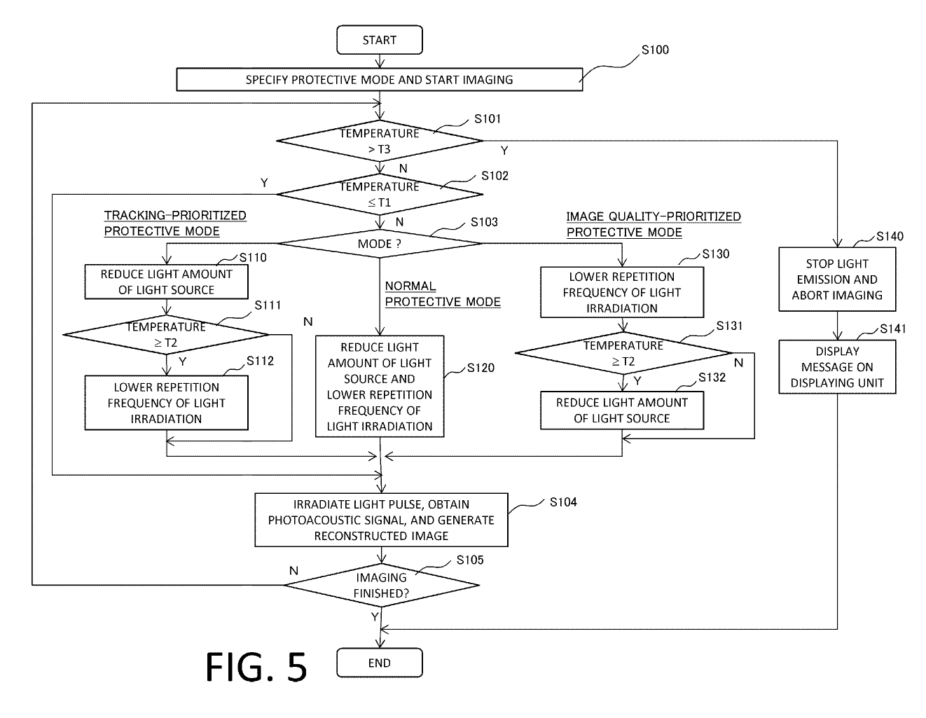

Next, contents of control in each protective mode will be described with specificity using the flow chart shown in FIG. 5.

Step S100. First, the user specifies a protective mode and starts imaging. At this point, a default repetition frequency of light irradiation and a default light amount are used. Moreover, the user need not necessarily specify a protective mode when a default protective mode is provided.

Step S101. Next, the computer determines whether a temperature detected by the temperature sensor 200 (hereinafter, also simply referred to as the temperature of the temperature sensor 200) is a value larger than a threshold T3 (a value larger than a third threshold) or a value not more than the threshold T3. The threshold T3 is an upper limit threshold at which light emission by the light source 111 must be stopped immediately when exceeded. In this case, the threshold T3 is set to 60° C. When it is determined in step S101 that the temperature of the temperature sensor 200 is higher than the threshold T3, the operation makes a transition to step S140 to stop light emission by the light source 111 and also abort acquisition (imaging) of a reconstructed image. In addition, a message reading “Imaging has been aborted due to rise in probe temperature” or the like is displayed on the displaying unit 160. Alternatively, a notification combined with a beep sound may be performed (step S141). Subsequently, imaging is suspended.

Step S102. On the other hand, when it is determined in step S101 that the temperature of the temperature sensor 200 is not more than the threshold T3, the operation proceeds to step S102. In step S102, the computer determines whether the temperature of the temperature sensor 200 is a value equal to or smaller than a threshold T1 (a value equal to or smaller than a first threshold) or a value larger than the threshold T1. The threshold T1 is set to a temperature at which, since the temperature of the probe 180 is moderately high, heat generation by the light source 111 needs to be suppressed. In this case, the threshold T1 is set to 40° C. When it is determined in step S102 that the temperature of the temperature sensor 200 is equal to or lower than the threshold T1, since the temperature of the probe 180 is sufficiently low and the default repetition frequency of light irradiation and the default light amount can be maintained without incident, the operation proceeds to step S104 without changing the repetition frequency of light irradiation and the light amount.

Subsequently, in step S104, a light pulse is irradiated, a corresponding photoacoustic wave is received, and a reconstructed image is generated and displayed on the displaying unit 160. Alternatively, in S104, using a notifying unit, the user may be notified of information indicating what the protective mode currently in operation is or information indicating the present light amount and the resent repetition frequency. As the notifying unit, the displaying unit 160 may be used or a voice output apparatus (not shown) may be used.

Step S103. On the other hand, a determination made in step S102 that the temperature of the temperature sensor 200 is higher than the threshold T1 means that the temperature of the probe 180 is moderately high. Therefore, the operation makes a transition to a next step S103 to determine which protective mode is the present protective mode.

Steps S110 to S112. When it is determined in step S103 that the “tracking-prioritized protective mode” is being selected, the operation makes a transition to step S110. In step S110, the controlling unit reduces the light amount of the light source 111 in order to suppress the exothermic amount per unit time which is released from the light source 111.

In a next step S111, the computer determines whether the temperature of the temperature sensor 200 is a value equal to or larger than a threshold T2 (a value equal to or larger than a second threshold) or a value smaller than the threshold T2. The threshold T2 is selected from temperatures between the thresholds T3 and T1. In this case, the threshold T2 is set to 50° C. When the temperature of the temperature sensor 200 is lower than the threshold T2, since this means that a temperature reduction effect due to reducing the light amount has been sufficiently produced, the operation proceeds to step S104.

On the other hand, when it is determined in step S111 that the temperature of the temperature sensor 200 is equal to or higher than the threshold T2, this means that simply reducing the light amount was unable to produce a sufficient temperature reduction effect. Therefore, the operation proceeds to step S112 to lower the repetition frequency of light irradiation (to increase the light emission period) in order to limit the exothermic amount per unit time which is released from the light source 111. The repetition frequency of light irradiation and the irradiated light amount are determined in this manner and the operation proceeds to a next step S104. In step S104, a light pulse is irradiated at the determined repetition frequency and light amount, a photoacoustic signal is received, and a reconstructed image is generated and displayed.

Moreover, the process in step S112 is not limited to lowering the repetition frequency. For example, in the tracking-prioritized protective mode, control may be performed so that the exothermic amount is reduced solely by a process of reducing the irradiated light amount. In step S132 related to the image quality-prioritized protective mode to be described later, the exothermic amount may be similarly reduced solely by lowering the repetition frequency.

It should be added that the determinations made using the threshold T2 and the threshold T3 are not necessarily essential and that a simpler process flow than the flow shown in FIG. 5 may be adopted. For example, a process flow may be adopted in which the computer determines whether the temperature of the temperature sensor 200 is higher than the threshold T1 or equal to or lower than the threshold T1 and, when the temperature is higher than the threshold T1, the light amount or the repetition frequency is lowered until the temperature is not higher than the threshold T1.

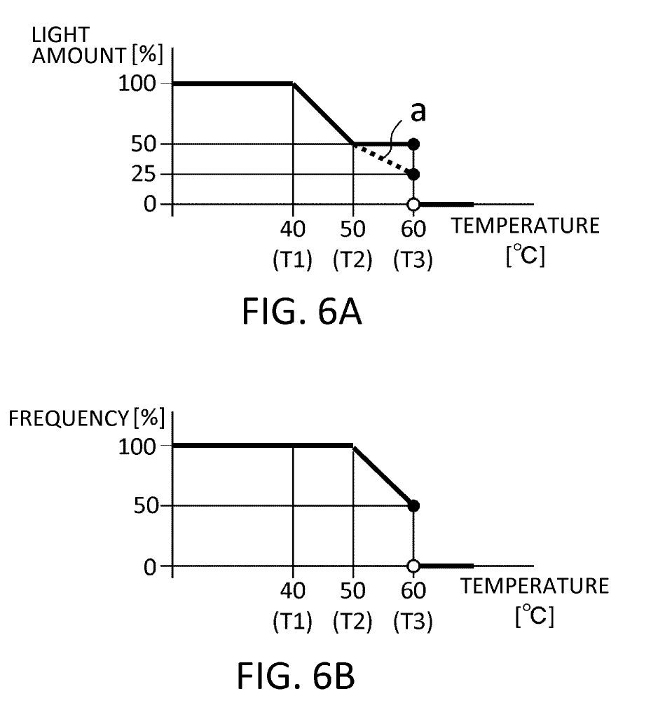

The method of determining the repetition frequency of light irradiation and the irradiated light amount in steps S110 to S112 will be described with greater specificity based on the graph shown in FIGS. 6A and 6B. FIG. 6A is a graph indicating control of an irradiated light amount in accordance with a temperature of a temperature sensor. A horizontal axis represents the temperature of the temperature sensor, and a vertical axis represents an intensity ratio of a light amount irradiated in step S104 with respect to a default light amount (100%). For example, when the default light amount is 0.01 [J] and the temperature of the temperature sensor is 50° C., the light amount is set to 50 [%] or, in other words, 0.005 [J]. In addition, at temperatures exceeding 50° C., the light amount may be maintained as indicated by a solid line or may be reduced as indicated by a dotted line (reference character a).

FIG. 6B is a graph indicating control of a repetition frequency of light irradiation in accordance with a temperature of a temperature sensor. A horizontal axis represents the temperature of the temperature sensor, and a vertical axis represents a ratio of a repetition frequency when light is irradiated in step S104 with respect to a default repetition frequency of light irradiation (100%). For example, when the default repetition frequency is 20 [Hz], an actual repetition frequency decreases to 50% or, in other words, 10 [Hz] if the temperature of the temperature sensor is 60° C.

With control such as that shown in FIGS. 6A and 6B, even when the temperature of the temperature sensor is high, the exothermic amount per unit time of the light source 111 can be reduced and the temperature of the probe 180 can be lowered. In the example shown in FIGS. 6A and 6B, with respect to exothermic amount reduction, a contribution degree of suppressing the light amount is larger than a contribution degree of lowering the repetition frequency. Moreover, a ratio of the default light amount to the actual irradiated light amount and a ratio of the default repetition frequency to the actual repetition frequency in FIGS. 6A and 6B are merely examples and other values may be used instead.

A flow in which determinations are made and control is performed based on the thresholds T1, T2, and T3 has been described above. With such a flow, since the light amount and the repetition frequency of light irradiation can be readily defined using mathematical expressions, a capacity of a control program can be reduced. However, the light amount and the repetition frequency of light irradiation may be determined by storing the characteristics shown in FIGS. 6A and 6B as a conversion table in a storage unit and referring to the conversion table based on temperature.

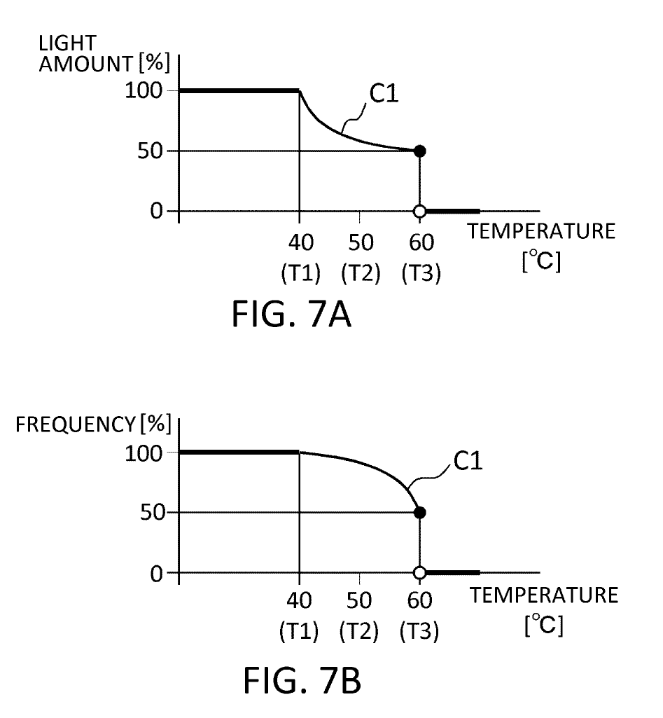

In addition, when using a conversion table, a conversion table in which the light amount and the repetition frequency change gradually as shown in FIGS. 7A and 7B may be used. When the conversion table shown in FIGS. 7A and 7B is used, as the temperature of the probe 180 rises, control is performed so as to reduce the irradiated light amount by a larger amount than an amount by which the repetition frequency of light irradiation is lowered. In other words, with respect to temperature suppression, control is performed such that a contribution degree of reducing the light amount is larger than a contribution degree of lowering the repetition frequency. As a result, when the temperature of the probe 180 is high, the exothermic amount per unit time of the light source 111 can be lowered while maintaining trackability.

Steps S130 to S132. When it is determined in step S103 that the “image quality-prioritized protective mode” is being selected, the operation makes a transition to step S130. In step S130, the repetition frequency of light irradiation by the light source 111 is lowered (the light emission period is increased) in order to limit the exothermic amount per unit time which is released from the light source 111. In a next step S131, a determination is made as to whether the temperature of the temperature sensor 200 is equal to or higher than the threshold T2. The threshold T2 is selected from temperatures between the thresholds T3 and T1. In this case, the threshold T2 is set to 50° C. When the temperature of the temperature sensor 200 is lower than the threshold T2, since this means that a sufficient temperature reduction effect has been produced by lowering the repetition frequency, the operation proceeds to step S104.

When it is determined in step S131 that the temperature of the temperature sensor 200 is equal to or higher than the threshold T2, this means that simply lowering the repetition frequency was unable to produce a sufficient temperature reduction effect. Therefore, the operation proceeds to step S132 to reduce the irradiated light amount in order to limit the exothermic amount per unit time which is released from the light source 111. The repetition frequency of light irradiation and the irradiated light amount are determined in this manner and the operation proceeds to a next step S104. In step S104, a light pulse is irradiated at the determined repetition frequency and light amount, a photoacoustic signal is received, and a reconstructed image is generated and displayed.

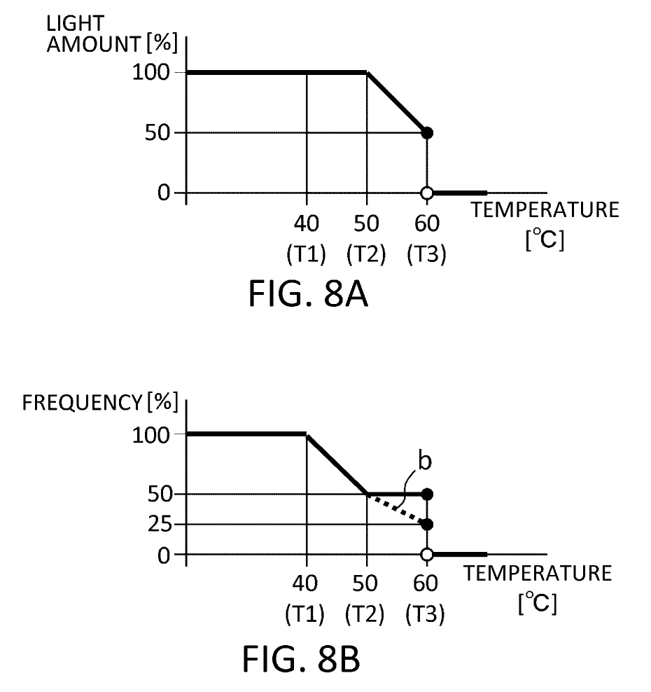

The method of determining the repetition frequency of light irradiation and the irradiated light amount in steps S130 to S132 will be described with greater specificity based on the graph shown in FIGS. 8A and 8B. FIG. 8A is a graph indicating control of an irradiated light amount in accordance with a temperature of a temperature sensor. A horizontal axis represents the temperature of the temperature sensor, and a vertical axis represents an intensity ratio of a light amount irradiated in step S104 with respect to a default light amount (100%). For example, when the default light amount is 0.01 [J] and the temperature of the temperature sensor is 50° C., the light amount is set to 100 [%] or, in other words, 0.01 [J], and when the temperature of the temperature sensor is 60° C., the light amount is set to 50 [%] or, in other words, 0.005 [J].

FIG. 8B is a graph indicating control of a repetition frequency of light irradiation in accordance with a temperature of a temperature sensor. A horizontal axis represents the temperature of the temperature sensor, and a vertical axis represents a ratio of a repetition frequency when light is irradiated in step S104 with respect to a default repetition frequency of light irradiation (100%). For example, when the default repetition frequency is 20 [Hz], an actual repetition frequency decreases to 50% or, in other words, 10 [Hz] if the temperature of the temperature sensor is 50° C. In addition, at temperatures exceeding 50° C., the repetition frequency may be maintained as indicated by a solid line or may be lowered as indicated by a dotted line (reference character b).

With control such as that shown in FIGS. 8A and 8B, even when the temperature of the temperature sensor is high, the exothermic amount per unit time of the light source 111 can be reduced and the temperature of the probe 180 can be lowered. In the example shown in FIGS. 8A and 8B, with respect to exothermic amount reduction, a contribution degree of lowering the repetition frequency is larger than a contribution degree of suppressing the light amount. Moreover, a ratio of the default light amount to the actual irradiated light amount and a ratio of the default repetition frequency to the actual repetition frequency in FIGS. 8A and 8B are merely examples and other values may be used instead.

A flow in which determinations are made and control is performed based on the thresholds T1, T2, and T3 has been described above. With such a flow, since the light amount and the repetition frequency of light irradiation can be readily defined using mathematical expressions, a capacity of a control program can be reduced. However, the light amount and the repetition frequency of light irradiation may be determined by storing the characteristics shown in FIGS. 8A and 8B as a conversion table in a storage unit and referring to the conversion table based on temperature.

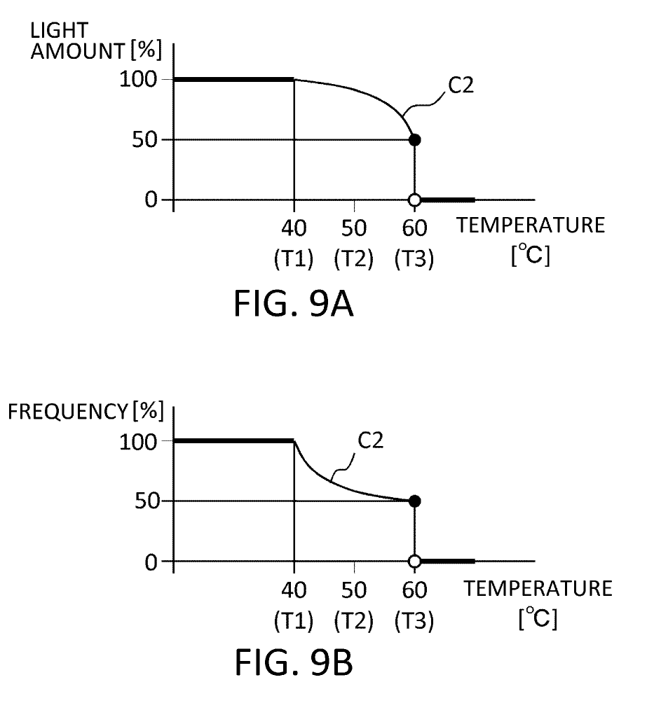

In addition, when using a conversion table, a conversion table in which the light amount and the repetition frequency gradually change as shown in FIGS. 9A and 9B may be used. When the conversion table shown in FIGS. 9A and 9B is used, as the temperature of the probe 180 rises, control is performed so as to lower the repetition frequency of light irradiation by a larger amount than an amount by which the irradiated light amount is reduced. In other words, with respect to temperature suppression, control is performed such that a contribution degree of lowering the repetition frequency is larger than a contribution degree of reducing the light amount. As a result, when the temperature of the probe 180 is high, the exothermic amount per unit time of the light source 111 can be lowered while maintaining image quality (S/N).

Step S120. When it is determined in step S103 that the “normal protective mode” is being selected, the operation makes a transition to step S120. In step S120, both the repetition frequency of light irradiation and the irradiated light amount of the light source 111 are reduced in order to limit the exothermic amount per unit time which is released from the light source 111. In a next step S104, a light pulse is irradiated at the determined repetition frequency and irradiated light amount, a photoacoustic signal is received, and a reconstructed image is generated and displayed.

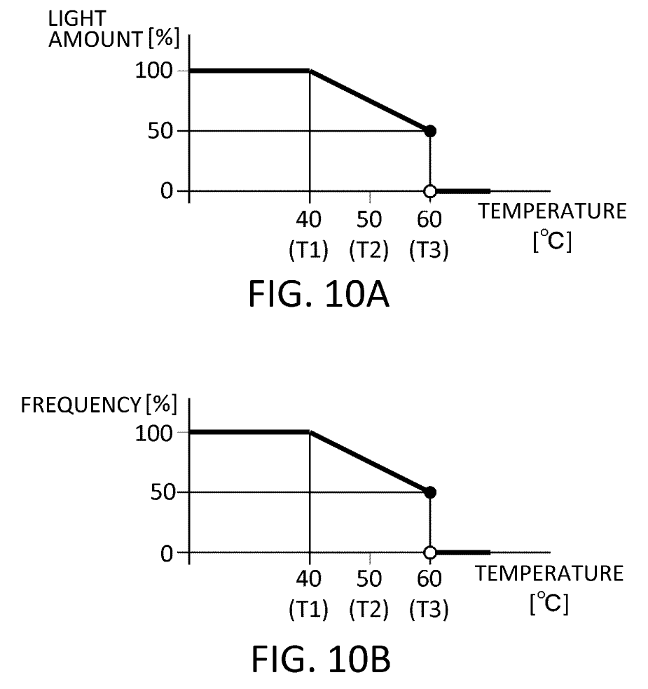

The method of determining the repetition frequency of light irradiation and the irradiated light amount in step S120 will be described with greater specificity based on the graph shown in FIGS. 10A and 10B. FIG. 10A is a graph indicating control of an irradiated light amount in accordance with a temperature of a temperature sensor. A horizontal axis represents the temperature of the temperature sensor, and a vertical axis represents an intensity ratio of a light amount irradiated in step S104 with respect to a default light amount (100%). For example, when the default light amount is 0.01 [J] and the temperature of the temperature sensor is 40° C., the light amount is set to 100 [%] or, in other words, 0.01 [J], and when the temperature of the temperature sensor is 60° C., the light amount is set to 50 [%] or, in other words, 0.005 [J].

FIG. 10B is a graph indicating control of a repetition frequency of light irradiation in accordance with a temperature of a temperature sensor. A horizontal axis represents the temperature of the temperature sensor, and a vertical axis represents a ratio of a repetition frequency when light is irradiated in step S104 with respect to a default repetition frequency of light irradiation (100%). For example, when the default frequency is 20 [Hz] and the temperature of the temperature sensor is 40° C., the actual repetition frequency is set to 100 [%] or, in other words, 20 [Hz], and when the temperature of the temperature sensor is 60° C., the actual repetition frequency is set to 50 [%] or, in other words, 10 [Hz].

With control such as that shown in FIGS. 10A and 10B, even when the temperature of the temperature sensor is high, the exothermic amount per unit time of the light source 111 can be reduced and the temperature can be lowered. In the example shown in FIGS. 10A and 10B, with respect to exothermic amount reduction, a contribution degree of suppressing the light amount and a contribution degree of lowering the repetition frequency are comparable to each other. Moreover, a ratio of the default irradiated light amount to the actual irradiated light amount and a ratio of the default repetition frequency to the actual repetition frequency in FIGS. 10A and 10B are merely examples and other values may be used instead. In other words, as long as control can be performed so that the user does not sense a significant degradation of any of image quality (S/N) and trackability, image quality (S/N) and trackability need not be reduced at the same proportion.

A flow in which determinations are made and control is performed based on the thresholds T1 and T3 has been described above. With such a flow, since the irradiated light amount and the repetition frequency of light irradiation can be readily defined using mathematical expressions, a capacity of a control program can be reduced. On the other hand, the irradiated light amount and the repetition frequency of light irradiation may be determined by storing the characteristics shown in FIGS. 10A and 10B as a conversion table in a storage unit and referring to the conversion table based on temperature.

In the “normal protective mode”, when the temperature of the probe 180 is high, the exothermic amount per unit time of the light source 111 can be lowered while providing a balance between the image quality (S/N) of each reconstructed image and trackability.

As described above, using a light source control method such as that described in the present embodiment enables a rise in temperature of a photoacoustic probe including a light source to be appropriately suppressed. In addition, since the user can select a desired protective mode, for example, suitable image display in accordance with needs can be performed even during real-time display.

### Second Embodiment

In the first embodiment, a control method of a repetition frequency and an irradiated light amount in accordance with a temperature of the probe 180 is changed for each specified protective mode. On the other hand, the second embodiment does not have protective modes. Instead, in the second embodiment, the repetition frequency and the irradiated light amount are controlled in accordance with the temperature of the probe 180 while referring to a movement (speed) of the probe 180.

Since an apparatus configuration according to the second embodiment is approximately similar to that shown in FIGS. 1, 2, and 3, only differences therefrom will be described. The probe 180 according to the second embodiment further internally includes a speed sensor as a speed information acquiring unit which acquires a speed when the probe 180 moves. A speed sensor can be realized by, for example, integrating a signal of an acceleration sensor and calculating speed. However, the speed information acquiring unit may adopt any system as long as speed can be acquired and is not limited to those using an acceleration sensor.

Even in the second embodiment, the repetition frequency of light irradiation and the irradiated light amount are optimally controlled in accordance with a temperature detected by the temperature sensor 200 in a similar manner to the first embodiment. However, in the second embodiment, instead of a fixed protective mode, the repetition frequency and the irradiated light amount are dynamically controlled in accordance with the temperature detected by the temperature sensor 200 while referring to a magnitude (speed) of speed of the probe 180.

Generally, resolution of a human eye declines with respect to a moving subject. On the other hand, when a human views a moving subject, continuity of the movement declines when an update frequency (a refresh frequency) of a screen of a display apparatus is low and the movement appears jerky. In other words, with respect to a moving subject, moving image display which emphasizes image update frequency over image resolution is suitable. In the second embodiment, such characteristics are utilized to dynamically control the repetition frequency of light irradiation and the irradiated light amount in accordance with a speed of the probe 180 when a temperature of the probe 180 rises.

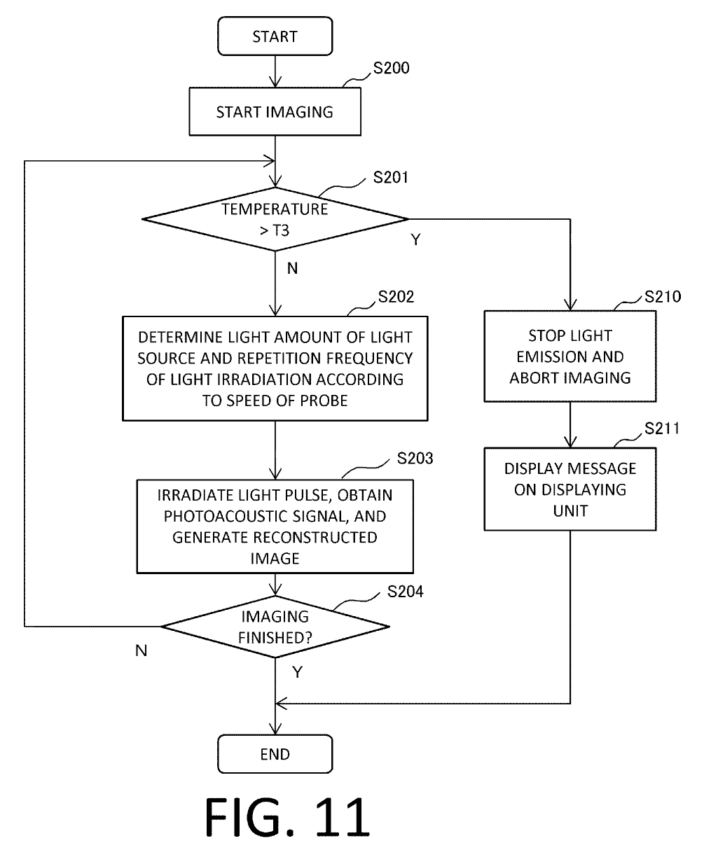

A control method according to the second embodiment will be described with reference to the flow chart shown in FIG. 11.

Step S200. First, imaging is started under an instruction from the user.

Step S201. Next, the computer determines whether the temperature of the temperature sensor 200 is higher than the threshold T3 or equal to or lower than the threshold T3. In this case, the threshold T3 is set to 60° C. When it is determined in step S201 that the temperature of the temperature sensor 200 is higher than the threshold T3, the operation makes a transition to step S210 to stop light emission by the light source 111 and also abort acquisition (imaging) of a reconstructed image. In addition, a message reading “Imaging has been aborted due to rise in probe temperature” or the like is displayed on the displaying unit 160 (step S211). Subsequently, imaging is suspended.

Step S202. On the other hand, when it is determined in step S201 that the temperature of the temperature sensor 200 is equal to or lower than the threshold T3, the operation proceeds to step S202. In step S202, while referring to the speed of the probe, the computer determines whether or not the default repetition frequency or the default light amount is to be changed and, if so, determines a new value in accordance with the temperature of the temperature sensor 200.

Specifically, when the speed of the probe is relatively slow or when the probe is stationary, since a movement of an obtained reconstructed image is also slow, a sense that trackability is retarded is small even if the refresh frequency is low. In addition, when the speed of the probe is relatively slow or when the probe is stationary, a state conceivably exists where the user is focusing on a particular portion of an object and desires to view the particular portion in detail. In consideration thereof, when reducing the exothermic amount per unit time of the light source 111, the refresh frequency may be lowered (the repetition frequency of light irradiation may be lowered) while minimizing a reduction in the irradiated light amount. Accordingly, an image with a low refresh frequency but good image quality (favorable S/N) can be generated.

On the other hand, when the speed of the probe is relatively high, since the movement of the obtained reconstructed image becomes faster, a sense that trackability is retarded increases unless a high refresh frequency is maintained. In addition, when movement of the obtained reconstructed image is fast, since it is difficult to view details of the image, no problem arises even when S/N of each reconstructed image is not good. In consideration thereof, when reducing the exothermic amount per unit time of the light source 111, the irradiated light amount may be lowered while minimizing a reduction in the refresh frequency.

Steps S203 and S204. A light pulse is irradiated at the repetition frequency of light irradiation and the irradiation light amount determined in S202, a photoacoustic signal is received, and a reconstructed image is generated and displayed. Subsequently, in step S204, a determination is made on whether or not imaging has been finished and, if not, the operation returns to step S201 to repeat imaging.

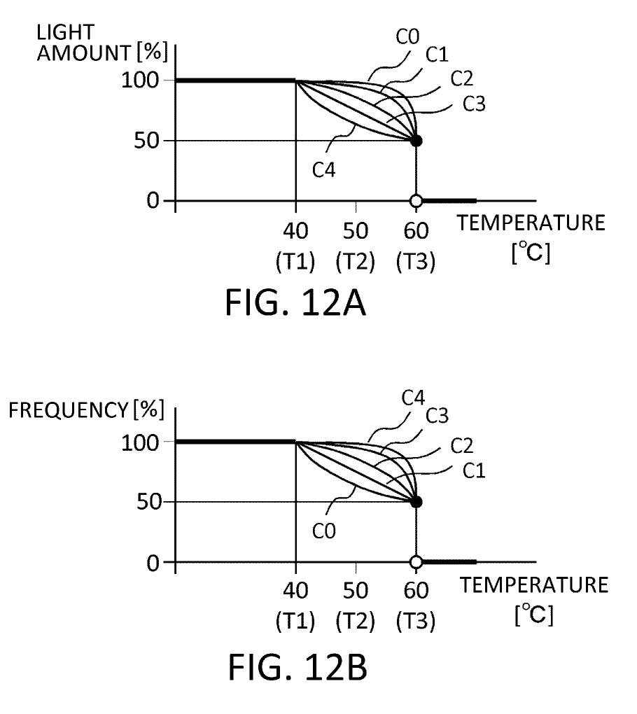

Next, the method of determining the repetition frequency of light irradiation and the irradiated light amount in step S202 will be described with greater specificity based on the graph shown in FIGS. 12A and 12B. FIG. 12A is a graph for explaining a method of determining an irradiated light amount in accordance with a temperature of a temperature sensor while referring to a speed of a probe. A horizontal axis represents the temperature of the temperature sensor, and a vertical axis represents a ratio of a light amount irradiated in step S203 with respect to a default light amount (100%).

FIG. 12B is a graph for explaining a method of determining a repetition frequency of light irradiation in accordance with a temperature of a temperature sensor while referring to a speed of a probe. A horizontal axis represents the temperature of the temperature sensor, and a vertical axis represents a ratio of a repetition frequency of light irradiation when light is irradiated in step S203 with respect to a default repetition frequency of light irradiation (100%).

Characteristic curves C0 to C4 in FIGS. 12A and 12B are selected according to the speed of the probe 180. For example, when the speed of the probe 180 is significantly low or when the probe 180 is stationary, the characteristic curve C0 is selected so as to reduce the exothermic amount per unit time of the light source 111 while maintaining the light amount. On the other hand, when the speed of the probe 180 is high, the characteristic curve C4 is selected so as to reduce the exothermic amount per unit time of the light source 111 while maintaining the refresh frequency. When the probe is at an intermediate speed, the characteristic curves C1 to C3 are selected in accordance with the speed.

Moreover, the number of characteristic curves is not limited to five. A sense of discomfort when switching between characteristics is reduced by using a larger number of characteristics. In addition, the shapes of the characteristic curves shown in FIGS. 12A and 12B are examples and other characteristic curves may be used instead. Furthermore, while the term “curve” is used in this description, curved shapes of graphs indicating characteristics are not essential requirements. Moreover, the control according to the present embodiment can also be realized using a function having sensor temperature and probe speed as variables instead of using graphs such as those shown in FIGS. 12A and 12B.

Features of the characteristics shown in FIGS. 12A and 12B are as follows. When arbitrary speeds V1 and V2 have a relationship expressed as V1<V2, by controlling the repetition frequency of light irradiation at the speed V1 to be lower than the repetition frequency of light irradiation at the speed V2 determined based on the temperature of a temperature sensor, a rise of the temperature of the probe 180 is suppressed in a more preferable manner. FIGS. 12A and 12B indicate that, when reducing heat generation by the light source, the higher the probe speed, control is performed so that the contribution degree of reducing the light amount becomes larger than the contribution degree of lowering the repetition frequency, and the lower the probe speed, control is performed so that the contribution degree of lowering the repetition frequency becomes larger than the contribution degree of reducing the light amount.

As described above, according to the second embodiment of the present invention, the trouble by the user of having to specify a protective mode and the like can be reduced and, in addition, a light amount and a repetition frequency of light irradiation can be optimally determined in accordance with a speed of a probe. As a result, a rise in temperature of the probe 180 can be prevented without the user experiencing a sense of degradation when viewing a reconstructed image.

### Third Embodiment

In the third embodiment, an exothermic amount per unit time of the light source 111 is suppressed by controlling a repetition frequency and an irradiated light amount in accordance with a temperature of the probe 180 while referring to a pressing force of the probe 180. Since an apparatus configuration according to the third embodiment is approximately similar to that shown in FIGS. 1, 2, and 3, only differences therefrom will be described. The probe 180 according to the third embodiment further internally includes a pressure sensor as a pressure information acquiring unit. The pressure sensor is a sensor which detects a force (a pressing force) by which a contact surface of the receiving unit 120 of the probe 180 presses against the object. The third embodiment differs from the second embodiment in that the repetition frequency of light irradiation and the irradiated light amount in accordance with a temperature detected by the temperature sensor 200 are dynamically controlled while referring to the pressing force of the probe 180 instead of the speed of the probe 180.

Generally, when the user observes an object using the probe 180, the deeper the region in focus, the greater the tendency of the user to involuntarily press the probe 180 hard against the object. In the third embodiment, such characteristics are utilized to dynamically control the repetition frequency and the light amount while referring to the pressing force of the probe 180.

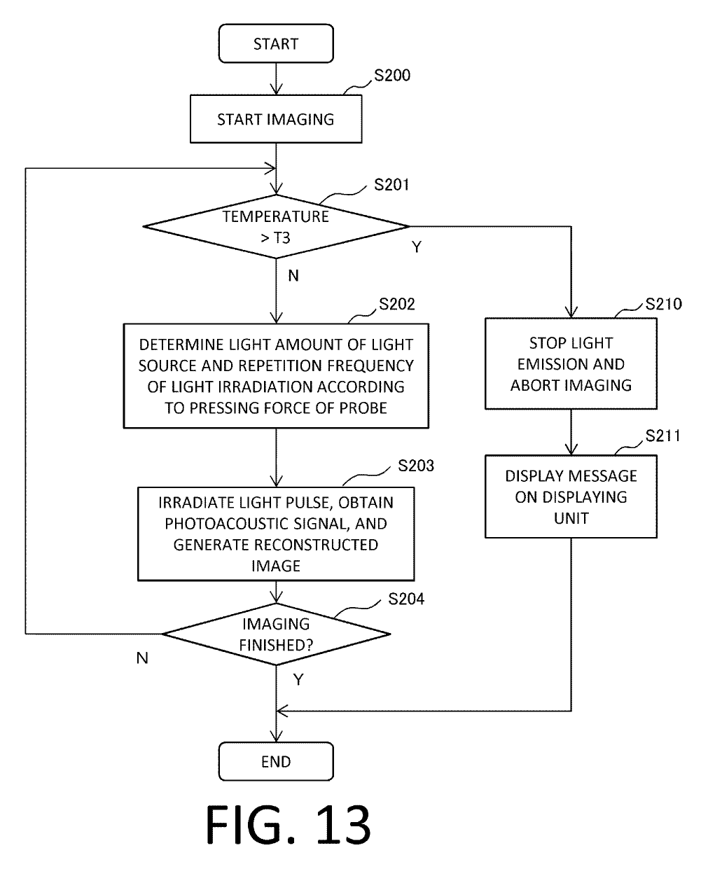

A control method according to the third embodiment will be described with reference to the flow chart shown in FIG. 13. Since the only difference between FIG. 11 and FIG. 13 is that step S202 in FIG. 11 has been replaced with step S220 in FIG. 13, descriptions of steps other than S220 will be omitted. In step S220, while referring to the pressing force of the probe, the computer determines whether or not the default repetition frequency or the default irradiated light amount is to be changed and, if so, determines a new value in accordance with the temperature of the temperature sensor 200.

Specifically, when the pressing force is relatively large, the user is often observing a deep portion. In consideration thereof, when reducing the exothermic amount per unit time of the light source 111, the refresh frequency may be lowered (the repetition frequency of light irradiation may be lowered) while minimizing a reduction in the irradiated light amount. Accordingly, an image with a low refresh frequency but good image quality (favorable S/N) can be generated. Light tends to be susceptible to attenuation due to absorption and scattering inside the object and hardly reaches deep portions. In consideration thereof, the irradiated light amount is favorably maintained when observing deep portions.

On the other hand, when the pressing force is relatively small, the user is often observing a shallow portion. In consideration thereof, when reducing the exothermic amount per unit time of the light source 111, the irradiated light amount may be reduced while minimizing a reduction in the refresh frequency.

Next, the method of determining the repetition frequency of light irradiation and the irradiated light amount in step S220 will be described with reference to the graph shown in FIGS. 12A and 12B which has also been used in the second embodiment. In the third embodiment, the characteristic curves C0 to C4 in FIGS. 12A and 12B are selected according to the pressing force of the probe 180. For example, when the pressing force of the probe 180 is large, the characteristic curve C0 is selected so as to reduce the exothermic amount per unit time of the light source 111 while maintaining the light amount. On the other hand, when the pressing force of the probe 180 is small, the characteristic curve C4 is selected so as to reduce the exothermic amount per unit time of the light source 111 while maintaining the refresh frequency. When the pressing force of the probe has an intermediate value, the characteristic curves C1 to C3 are selected in accordance with the value.

Moreover, the number of characteristic curves is not limited to five. A sense of discomfort when switching between characteristics is reduced by using a larger number of characteristics. In addition, the shapes of the characteristic curves shown in FIGS. 12A and 12B are examples and other characteristic curves may be used instead. Moreover, the control according to the present embodiment can also be realized using a function having a sensor temperature and a pressing force of a probe as variables instead of using graphs such as those shown in FIGS. 12A and 12B.

In the third embodiment, the characteristics shown in FIGS. 12A and 12B can be interpreted as follows. When arbitrary pressing forces P1 and P2 have a relationship expressed as P1<P2, by controlling the irradiated light amount at the pressing force P2 to be larger than the irradiated light amount at the pressing force P1 determined based on the temperature of a temperature sensor, a rise of the temperature of the probe 180 is suppressed in a more preferable manner. In the third embodiment, FIGS. 12A and 12B indicate that, when reducing heat generation by the light source, the smaller the pressing force, control is performed so that the contribution degree of reducing the light amount becomes larger than the contribution degree of lowering the repetition frequency, and the larger the pressing force, control is performed so that the contribution degree of lowering the repetition frequency becomes larger than the contribution degree of reducing the light amount.

As described above, according to the third embodiment of the present invention, the trouble by the user of having to specify a protective mode and the like can be reduced and, in addition, an irradiated light amount and a repetition frequency of light irradiation can be optimally determined in accordance with a pressing force of a probe. As a result, a rise in temperature of the probe 180 can be prevented without the user experiencing a sense of degradation of S/N due to an insufficient light amount even when viewing a deep portion.

### Fourth Embodiment

In the respective embodiments described above, an irradiated light amount and a repetition frequency are determined in accordance with a temperature of a temperature sensor. In the fourth embodiment, the irradiated light amount and the repetition frequency are determined in consideration of a change in temperature in addition to the temperature of the temperature sensor. A configuration of an apparatus according to the fourth embodiment is the same as those of the first to third embodiments.

A control method according to the fourth embodiment can be applied in combination with the respective embodiments described above. Contents of the fourth embodiment will now be described using FIGS. 6A and 6B described earlier. FIGS. 6A and 6B are graphs related to control of the irradiated light amount and the repetition frequency in accordance with a probe temperature. In the first to third embodiments, while a temperature at a certain time point is used, information related to a change in temperature (for example, information indicating that the temperature is rising or the temperature is dropping) is not used. On the other hand, in the fourth embodiment, a trend in temperature change is also referred to. For example, when the temperature is 50° C., if the temperature is rising, the exothermic amount per unit time of the light source 111 is desirably reduced by a larger amount. In addition, when the temperature is dropping from the same 50° C., the exothermic amount per unit time of the light source 111 need not be reduced as much.

A method of realizing control using such trends in temperature change will now be described. The computer calculates a difference between the temperature of the temperature sensor at the present time point and a previous temperature of the temperature sensor at a time point which precedes the present by a certain amount of time. When the temperature is rising, the temperature difference has a positive value, and when the temperature is dropping, the temperature difference has a negative value. The computer multiplies the difference by a coefficient, adds the multiplied difference to the temperature of the temperature sensor, and obtains a new temperature (a predicted temperature) at a time point where a certain amount of time has elapsed. Subsequently, the predicted temperature is applied to the horizontal axis of the graph shown in FIGS. 6A and 6B to determine the light amount and the repetition frequency of light irradiation. Such a process can be applied to the respective graphs in FIGS. 6A and 6B to FIGS. 10A and 10B according to the first embodiment and to the graph in FIGS. 12A and 12B according to the second and third embodiments. In addition, the process can also be applied when the light amount and the repetition frequency are obtained using functions instead of graphs.

According to the fourth embodiment of the present invention, in addition to the effects of the first to third embodiments, the repetition frequency of light irradiation and the irradiated light amount can be controlled and the exothermic amount per unit time of the light source 111 can be suppressed based on the temperature of the probe 180 and an amount of temperature change. In particular, when the temperature is on a rising trend, the exothermic amount can be preemptively suppressed. As a result, temperature control of the probe 180 can be performed in a more preferable manner.

### Fifth Embodiment

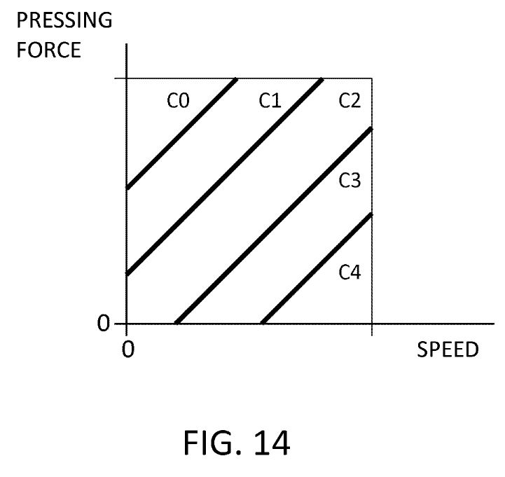

In the present invention, the second embodiment and the third embodiment can be used in combination. A computer according to the fifth embodiment uses both a speed of a probe acquired by a speed information acquiring unit and a pressing force of the probe acquired by a pressure information acquiring unit to determine an irradiated light amount and a repetition frequency. In this case, for example, a characteristic curve in accordance with the speed of the probe and the pressing force of the probe may be selected according to a graph such as that shown in FIG. 14. In other words, a characteristic curve in which the repetition frequency of light irradiation is maintained is selected when the speed is high and a characteristic curve in which the irradiated light amount is maintained is selected when the pressing force is large. Moreover, FIG. 14 is merely an example and a characteristic curve may be selected using other methods as long as the gist of the description provided above is satisfied.

### Sixth Embodiment

A rise in temperature of a probe due to heat generation by a light source may be suppressed based on a temperature of a temperature sensor by mounting a microcomputer or the like in the probe 180 itself and delegating the microcomputer to execute at least a part of the functions of the controlling unit 153. In this case, the photoacoustic probe itself functions as an object information acquiring apparatus. The sixth embodiment is even more preferable since an optimal control flow for suppressing temperature rise can be implemented for each probe type.

In addition, in the present invention, a refresh frequency (a repetition frequency of light irradiation) and an irradiated light amount are controlled to prevent the temperature of the probe 180 from rising. Therefore, a type of a current protective mode, information indicating whether or not the protective mode is currently in operation, a refresh frequency (a repetition frequency of light irradiation), and an irradiated light amount are favorably presented to the user using the displaying unit 160. Displaying these pieces of information together with an obtained reconstructed image is also favorable. When displaying the information together with a reconstructed image, a method of displaying the information superimposed on the reconstructed image or a method of displaying the information in a region surrounding the reconstructed image can be adopted.

### Seventh Embodiment

In the seventh embodiment, a configuration will be described in which, when a light amount produced by a light emission of one pulse is insufficient, a plurality of pulsed light emissions are performed, respective obtained photoacoustic signals are averaged to improve S/N, and a photoacoustic image is calculated based on the averaged photoacoustic signals. In this case, for the averaging, simple averaging, moving averaging, weighted averaging, and the like are preferably performed. In addition, other than averaging, any statistical processing for obtaining a signal usable in image reconstruction from a plurality of signals obtained based on a plurality of pulsed light emissions may be performed. The seventh embodiment is suitable in cases where an LD, an LED, or the like is used as the light source 111 and S/N of a photoacoustic signal by one pulsed light emission is not sufficient.

In the descriptions of the sixth and preceding embodiments, since configurations in which one pulsed light emission is performed in order to obtain one reconstructed image are adopted, a total amount of optical energy of one pulse is described and explained as an irradiated light amount. On the other hand, in the seventh embodiment, a plurality of pulsed light emissions are performed in order to obtain one reconstructed image and obtained photoacoustic signals are averaged. Therefore, in the seventh embodiment, a total light amount of the plurality of pulsed light emissions performed in order to obtain one reconstructed image is treated as being equivalent to the irradiated light amount described above. Such a treatment enables the control methods of an irradiated light amount of the respective embodiments described above to be applied to the present embodiment.

In addition, the “repetition frequency of light irradiation” in the respective embodiments described above corresponds to a frequency based on a period for acquiring a reconstructed image (a refresh frequency) instead of a frequency defined based on intervals at which a large number of pulsed light emissions are performed for averaging in the present embodiment.

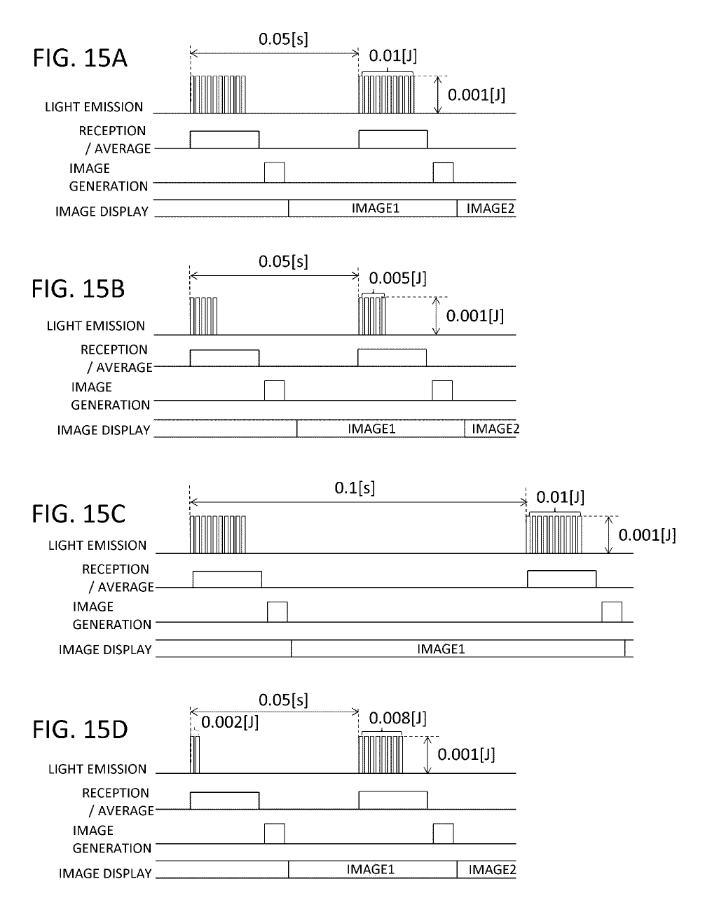

FIGS. 15A to 15D are timing charts for explaining a control method and an exothermic amount per unit time of the light source 111 according to the seventh embodiment. Since FIGS. 15A to 15D are approximately the same as FIGS. 4A to 4C, descriptions of overlapping portions will be omitted. FIGS. 15A to 15D show respective timings of emission of irradiation light, reception of a photoacoustic wave and averaging of signals, generation of image data, and display of image data. A vertical axis in the timing chart of “light emission” represents a light amount of each pulsed light emission in a plurality of pulsed light emissions. In addition, a total light amount due to the plurality of pulsed light emissions (the irradiated light amount according to the present embodiment) is also described.

Moreover, the difference from FIGS. 4A to 4C is that pulsed light emission is performed a plurality of times, obtained photoacoustic signals are averaged, and image reconstruction is performed based on the averaged photoacoustic signals. When pulsed light emission is performed a plurality of times in this manner, controlling a light amount itself of each pulsed light emission among the plurality of pulsed light emissions makes circuitry more complex. Therefore, in the seventh embodiment, a system is adopted in which a light amount of each pulsed light emission among the plurality of pulsed light emissions is fixed and the light amount (the irradiated light amount) is controlled by controlling the number of light emissions in the plurality of pulsed light emissions.

In addition, according to light amount (irradiated light amount) control such as that described above, since the light amount of each pulsed light emission among a plurality of pulsed light emissions is fixed, a light amount distribution (a light amount intensity) inside an object associated with each light emission among the plurality of pulsed light emissions does not change. Therefore, there is an advantage that a gain of an amplifier of the signal collecting unit 140 need not be controlled for each pulsed light emission.

In FIG. 15A, a refresh frequency of image display is set to 20 [Hz] which enables display so as to track a normal movement of the hand-held probe.

When photoacoustic measurement starts in FIG. 15A, at a timing indicated in “light emission”, the controlling unit 153 sets a light amount setting value of 0.01 [J] to the driver circuit 114. The light amount set at this point is a total light amount of a plurality of pulsed light emissions as described above. Based on a once-per-0.05 seconds light emission timing signal from the controlling unit 153, the driver circuit causes the light source 111 which is an LD, an LED, or the like to perform pulsed light emissions for the number of times corresponding to the light amount setting value. For example, when the light amount per pulse is 0.001 [J], the number of light emissions is 10 times. In addition, light emission intervals are, for example, 2 [msec].

Subsequently, at a timing indicated in “reception/averaging” in FIG. 15A, the receiving unit 120 respectively receives photoacoustic waves created due to a plurality of pulsed light emissions from the light source 111, and averages the received signals. Moreover, the averaging process need not be performed by the receiving unit 120. For example, the computing unit 151 may perform the averaging process or a circuit for performing the averaging process may be provided.

Subsequently, the computing unit 151 performs a reconstruction process based on an averaged photoacoustic signal output by the receiving unit 120 at a timing indicated in “image generation” in FIG. 15A, and generates image data.

Next, the controlling unit 153 transmits the image data to the displaying unit 160 and causes the displaying unit 160 to display an image based on the image data. The displaying unit 160 displays an image based on the image data during a period indicated in “image display” in FIG. 15A.

In the timing chart shown in FIG. 15A, an image 1 is first displayed for 0.05 seconds and an image 2 is next displayed for 0.05 seconds. By repeating the steps described above, image display based on new image data is updated every 0.05 seconds.

As described earlier, an exothermic amount per unit time of the hand-held probe is determined by an irradiated light amount and a repetition frequency of light irradiation. In the present embodiment, the irradiated light amount is a total light amount by a plurality of pulsed light emissions for obtaining one reconstructed image, and the repetition frequency of light irradiation is a frequency based on a period for acquiring a reconstructed image.

In the case of FIG. 15A, assuming that the photoelectric conversion efficiency with respect to supplied power is 10 [%] and setting the irradiated light amount to 0.01 [J] (light amount per pulsed light emission 0.001 [J]×10 times), the exothermic amount per unit time of the light source 111 is 0.009 [J]×10×(1/0.05)=1.8 [W].

By controlling light irradiation, reception of photoacoustic waves, and processing of received signals as in the present embodiment, even when a light amount of a light source is not sufficient, an image with good S/N can be reconstructed while receiving the effect of suppressing a rise in temperature according to the respective embodiments described earlier.

Modification

FIG. 15B is a timing chart which shares the same repetition frequency of light irradiation but differs in the irradiated light amount (the number of pulsed light emissions) amount from FIG. 15A. The repetition frequency in FIG. 15B is 20 [Hz] which is the same as in FIG. 15A. The light source 111 performs pulsed light emissions five times at 2 [mSec] intervals and at a period of 0.05 seconds. Since a display image can be updated every 0.05 seconds, trackability comparable to FIG. 15A is obtained. On the other hand, the irradiated light amount in FIG. 15B is set to 0.005 [J] (light amount per pulsed light emission 0.001 [J]×5 times) or, in other words, half of that in FIG. 15A. According to such settings, the exothermic amount per unit time of the light source 111 has declined to 0.9 [W].

FIG. 15C is a timing chart which shares the same irradiated light amount but differs in the repetition frequency of light irradiation from FIG. 15A. The irradiated light amount in FIG. 15C is 0.01 [J] (light amount per pulsed light emission 0.001 [J]×10 times) which is the same as in FIG. 15A. Therefore, an S/N ratio of each obtained reconstructed image is similar to that of the reconstructed images obtained in FIG. 15A. On the other hand, the repetition frequency of light irradiation in FIG. 15C is 10 [Hz] or, in other words, a period of 0.1 seconds which is twice the period shown in FIG. 15A. According to such settings, the exothermic amount per unit time of the light source 111 has declined to 0.9 [W].

As described above, the exothermic amount per unit time of the light source 111 can be controlled by the repetition frequency of light irradiation (a frequency based on the period for acquiring a reconstructed image) and the irradiated light amount (a light amount per pulsed light emission for obtaining one reconstructed image×number of light emissions: proportional to the number of light emissions).

In the description given above, in a plurality of pulsed light emissions for obtaining one reconstructed image, the light amount per pulsed light emission is the same (fixed value: 0.001 [J]). However, in the present invention, the light amount may differ for each pulsed light emission. Even in such cases, a total light amount by a plurality of pulsed light emissions for obtaining one reconstructed image may be treated as the irradiated light amount.

In addition, as shown in FIG. 15D, in order to control the exothermic amount, the irradiated light amount (a total light amount by a plurality of pulsed light emissions) may be changed for every period of the repetition frequency of light irradiation (every period for acquiring a reconstructed image). In FIG. 15D, a light amount of 0.002 [J] is used to reconstruct an image 1 and a light amount of 0.008 [J] is used to reconstruct an image 2. In this case, in correspondence with the irradiated light amount, S/N of a reconstructed image of a certain frame hardly deteriorates while S/N of a reconstructed image of another frame deteriorates.

When performing control such as that shown in FIG. 15D, since the refresh frequency is unchanged, trackability does not deteriorate. In addition, a reconstructed image with less S/N degradation can be acquired (image 2). Therefore, when desiring to acquire a still image, an image of a frame with a large irradiated light amount (image 2) may be selected. Performing such control enables a rise in temperature of the probe 180 to be prevented while achieving a balance between trackability and image quality.

Moreover, in FIG. 15D, the light amount of each pulsed light emission is constant (0.001 [J]). Therefore, as described above, a gain of the amplifier of the signal collecting unit 140 which corresponds to each of the plurality of pulsed light emissions can be fixed. In addition, since the photoacoustic signal in each of the plurality of pulsed light emissions is averaged, there is an advantage that reconstructions can be performed under the same conditions regardless of the number of pulsed light emissions corresponding to each irradiated light amount.

Furthermore, as shown in FIG. 15D, the method of changing an irradiated light amount for each image reconstruction can also be applied to configurations in which one image is reconstructed by one pulsed light emission as in the first to sixth embodiments described earlier. In this case, the light amount may be changed for each pulsed light emission and, at the same time, a gain of the amplifier of the signal collecting unit 140 may be made variable to correct a change in a photoacoustic signal due to the change in the irradiated light amount.

As described above, the repetition frequency of light irradiation (a frequency based on a period for acquiring a reconstructed image) and the irradiated light amount (a light amount per pulsed light emission for obtaining one reconstructed image×number of light emissions: proportional to the number of light emissions) shown in FIGS. 15A to 15D are merely an example. Changes may be made as appropriate in accordance with characteristics of the system, an image quality desired by the user, and the like.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-052902, filed on Mar. 17, 2017, and, Japanese Patent Application No. 2017-107949, filed on May 31, 2017, which are hereby incorporated by reference herein in their entirety.

What is claimed is:

1. A photoacoustic apparatus, comprising:
a probe configured to include a light source and a receiving unit receiving an acoustic wave generated from an object, which has been irradiated with light from the light source;
a temperature information acquiring unit configured to acquire a temperature of the probe; and
a controlling unit configured to control irradiation of light by the light source in accordance with the temperature.

2. The photoacoustic apparatus according to claim 1, wherein
the controlling unit is configured to control heat generation from the light source by controlling power supplied to the light source in a case where the temperature exceeds a first threshold.

3. The photoacoustic apparatus according to claim 2, wherein
the controlling unit is configured to control at least any of a light amount and a repetition frequency when light is irradiated.

4. The photoacoustic apparatus according to claim 3, wherein
the controlling unit is capable of operating in a plurality of modes for controlling the irradiation of light,
the plurality of modes at least including:
a mode in which, with respect to reducing heat generation from the light source, a contribution degree of the process of reducing the light amount is larger than a contribution degree of the process of lowering the repetition frequency; and
a mode in which, with respect to reducing heat generation from the light source, a contribution degree of the process of lowering the repetition frequency is larger than a contribution degree of the process of reducing the light amount.

5. The photoacoustic apparatus according to claim 4, wherein
the controlling unit is configured to perform, when the temperature is higher than the first threshold, a process with a larger contribution degree in a mode currently in operation from among the process of reducing the light amount and the process of lowering the repetition frequency and,
subsequently, when the temperature is equal to or higher than a second threshold that is higher than the first threshold, performs a process with a smaller contribution degree in a mode currently in operation from among the process of reducing the light amount and the process of lowering the repetition frequency.

6. The photoacoustic apparatus according to claim 4, wherein
the controlling unit is configured to determine the mode in accordance with an input from a user using an inputting unit or in accordance with a default setting.

7. The photoacoustic apparatus according to claim 3, further comprising
a notifying unit configured to notify a user of the light amount and the repetition frequency of light.

8. The photoacoustic apparatus according to claim 3, further comprising
a computing unit configured to acquire characteristics information on the object by using a signal output by the receiving unit in response to receiving the acoustic wave.

9. The photoacoustic apparatus according to claim 8, wherein
the controlling unit configured to cause a displaying unit to display, for each repetition frequency, an image indicating the characteristics information.

10. The photoacoustic apparatus according to claim 8, wherein
the light source is configured to perform one pulsed light emission for each period of the repetition frequency,
the receiving unit is configured to receive the acoustic wave based on the one pulsed light emission and outputs a signal, and
the computing unit is configured to acquire the characteristics information based on the signal, for each period of the repetition frequency.

11. The photoacoustic apparatus according to claim 8, wherein
the light source is configured to perform a plurality of pulsed light emissions for each period of the repetition frequency,
the receiving unit is configured to receive the acoustic wave for each of the plurality of pulsed light emissions, thereby outputting a plurality of signals, and
the computing unit is configured to acquire the characteristics information based on a signal obtained by averaging the plurality of signals, for each period of the repetition frequency.

12. The photoacoustic apparatus according to claim 11, wherein
the controlling unit is configured to control a total light amount in one period of the repetition frequency by controlling at least any of the number of light emissions in the plurality of pulsed light emissions and a light amount of each of the plurality of pulsed light emissions in one period of the repetition frequency.

13. The photoacoustic apparatus according to claim 1, wherein
the temperature information acquiring unit is configured to acquire, as the temperature of the probe, a temperature of a housing of the probe or a temperature in a vicinity of the light source included in the probe.

14. The photoacoustic apparatus according to claim 3, further comprising
a speed information acquiring unit configured to acquire a speed of the probe, wherein
the controlling unit is configured to control irradiation of light by the light source in accordance with the speed.

15. The photoacoustic apparatus according to claim 14, wherein
when reducing heat generation by the light source, the controlling unit is configured to perform control such that, the higher the speed is, the larger a contribution degree of a process of reducing the light amount is than a contribution degree of a process of lowering the repetition frequency.

16. The photoacoustic apparatus according to claim 3, further comprising
a pressure information acquiring unit configured to acquire a pressing force, applied when the probe is pressed against the object, and
the controlling unit is configured to control irradiation of light by the light source in accordance with the pressing force.

17. The photoacoustic apparatus according to claim 16, wherein
when reducing heat generation by the light source, the controlling unit is configured to perform control such that, the larger the pressing force is, the larger a contribution degree of a process of lowering the repetition frequency is than a contribution degree of a process of reducing the light amount.

18. The photoacoustic apparatus according to claim 1, wherein
the controlling unit is configured to determine the content of control of reducing heat generation from the light source based on a predicted temperature, which is obtained from a trend in a change in temperature of the probe.

19. A photoacoustic probe, comprising:
a light source;
a receiving unit configured to receive an acoustic wave generated from an object, which has been irradiated with light from the light source;
a temperature information acquiring unit configured to acquire a temperature of the photoacoustic probe; and
a controlling unit configured to control irradiation of light by the light source in accordance with the temperature.

20. A photoacoustic apparatus control method comprising:
operating a light source included in a probe to irradiate an object with light;
operating a receiving unit included in the probe to receive an acoustic wave generated from the object, which has been irradiated with the light;
operating a temperature information acquiring unit to acquire a temperature of the probe; and
operating a controlling unit to control irradiation of light by the light source in accordance with the temperature.
